(19) United States
(12) Patent Application Publication
(10) Pub. No.: US 2012/0085235 A1
(43) Pub. Date: Apr. 12, 2012

(54) GAS ADSORBENT

(75) Inventors: Guy De Weireld, Mons (BE); Lomig Hamon, Mons (BE); Christian Serre, Paris Cedex (FR); Thomas Devic, Paris Cedex (FR); Gérard Ferey, Paris Cedex (FR); Thierry Loiseau, Paris Cedex (FR)

(73) Assignees: CENTRE NATIONAL DE LA RECHERCHE SCIENTIFIQUE, Paris Cedex 16 (FR); UNIVERSITE DE MONS, Mons (BE)

(21) Appl. No.: 12/988,962

(22) PCT Filed: Apr. 22, 2009
(86) PCT No.: PCT/EP09/54836

§ 371 Date: Feb. 23, 2011

(30) Foreign Application Priority Data
Apr. 22, 2008 (GB) 0807299.3
Dec. 24, 2008 (GB) 0823514.5

(51) Int. Cl. B01J 20/22; B01D 53/02

(52) U.S. Cl. 95/136; 502/401; 95/135

(57) ABSTRACT

A method for separating a sulphur compound from a gas mixture. The method includes contacting a gas mixture with an adsorbent which includes a metal-organic framework (MOF) comprising a tridimensional succession of motifs having the formula:

MₘOₖXₗLₚ

wherein, inter glia,

M is a metal ion selected from the group consisting of Ti⁴⁺, V⁴⁺, Zr⁴⁺, Mn⁴⁺, Si⁴⁺, Al³⁺, Cr³⁺, V³⁺, Ga³⁺, In³⁺, Mn³⁺, Mn²⁺ and Mg²⁺, L is a spacer ligand including a radical having one or more carboxylate groups.

The present invention relates to metal-organic frameworks gas adsorbents, in particular sulphur compounds, e.g. hydrogen sulphide, adsorbents.

Sulphur compounds may be naturally present in natural gas or biogas and moreover, may be added as odorous compounds. Absorption techniques are known to remove the major part of such sulphur compounds, with amine treatments for example. However such processes do not entirely remove such sulphur compounds or provide a gas substantially free of sulphur compounds, i.e. with residual concentrations below 50 ppm mol. Other methods are known to further decrease the sulphur content of gases. One method uses activated carbons but its selectivity is poor (activated carbons also adsorb the main compound gas). To improve performance, activated carbons may be impregnated with NaOH or KOH but low ignition temperature is a disadvantage (risks of self-ignition). Another method uses zeolites. These offer better selectivity than activated carbon but become rapidly poisoned (and thus deactivated) after a number of high temperature and expensive regeneration cycles. There is thus a need for improved and/or alternative sulphur adsorbents and processes for capturing sulphur compounds, in particular adsorbents which may have a high sulphur selectivity, a strong chemical resistance to the corrosive sulphur gases and preferably, which may be regenerated without high energetic regeneration costs.

Metal-organic frameworks (MOFs), also called “hybrid porous crystallised solids”, are coordination polymers with a hybrid inorganic-organic framework comprising metal ions and organic ligands coordinated to the metal ions. These materials are organised as mono-, bi- or tri-dimensional networks wherein the metal clusters are linked to each other by spacer ligands in a periodic way. These materials have a crystalline structure and are generally porous. Various MOFs are already known for their good adsorption properties with respect to H₂, CH₄ or CO₂.

We have now found that selected metal-organic frameworks (MOFs) may also be particularly effective as sulphur compound capturing agents, in particular as hydrogen sulphide and mercaptans capturing agents. They may be used over a wide range of sulphur compound concentrations: they may be used to treat natural gas (with H₂S concentrations varying from a few ppm to 100 or 500 ppm) or to treat syngas produced from coal gasification (with H₂S concentrations varying from a few ppm to 0.5%), as well as biogas (with H₂S concentrations varying from a few ppm to 5%). They may be regenerated without high energetic regeneration costs (they may recover sulphur compounds in a reversible manner, thus without the requirement to regenerate thermally and so avoiding poisoning).

According to one of its aspects, the present invention provides a method as defined by claim 1. Other aspects of the invention are defined in other independent claims. The dependent claims define preferred and/or alternative aspects of the invention.

Metal-organic frameworks (MOFs) suitable for the present invention are preferably crystalline and porous (preferably with a regular porosity), and according to one embodiment, comprise a tridimensional succession of motifs having the formula:

MₘOₖXₗLₚ formula (I)

wherein
M is a metal ion selected from the group consisting of Ti⁴⁺, V⁴⁺, Zr⁴⁺, Mn⁴⁺, Si⁴⁺, Al³⁺, Cr³⁺, V³⁺, Ga³⁺, In³⁺, Mn³+, Mn²⁺ and Mg²⁺; preferably, M is selected from the group consisting of Ti⁴⁺, V⁴⁺, Zr⁴⁺, Al³⁺, Cr³⁺, V³⁺;
m is 1, 2, 3 or 4, preferably 1 or 3;
k is 0, 1, 2, 3 or 4, preferably 0 or 1;
l is 0, 1, 2, 3 or 4, preferably 0 or 1;
p is 1, 2, 3 or 4, preferably 1 or 3;
X is selected from the group consisting of OH⁻, Cl⁻, F⁻, I⁻, Br⁻, SO₄²⁻, NO₃⁻, ClO₄⁻, PF₆⁻, BF₃⁻, —, (COO)ₙ⁻, R¹—(S0₃)ₙ⁻, R¹—(PO₃)ₙ⁻, wherein R¹ is selected from the group consisting of hydrogen and C₁₋₁₂alkyl (which may be linear or branched and optionally substituted), and wherein n is 1, 2, 3 or 4; preferably, X is selected from the group consisting of OH⁻, Cl⁻, F⁻, SO₄²⁻, NO₃⁻, ClO₄⁻, PF₆⁻, —(COO)ₙ⁻.
L is a spacer ligand comprising a radical R comprising q carboxylate groups *—COO-#, wherein
   q is 1, 2, 3, 4, 5 or 6, preferably 2, 3, 4, 5 or 6, more preferably 2, 3 or 4;
   shows the carboxylate attachment point to the radical R;
   # shows the carboxylate attachment point to the metal ion M;
   R is selected from the group consisting of C₁₋₁₂alkyl, C₂₋₁₂alkene, C₂₋₁₂alkyne, mono- and poly-cyclic C₁₋₅₀aryl (optionally fused), mono- and poly-cyclic C₁₋₅₀heteroaryl (optionally fused) and organic radicals comprising a metal material selected from the group consisting of ferrocene, porphyrin, phthalocyanine and Schiff base R^{X1}R^{X2}—C═N—R^{X3}, wherein R^{X1} and ^{RX2} are independently selected from the group consisting of hydrogen, C₁₋₁₂alkyl, C₂₋₁₂alkene, C₂₋₁₂alkyne (which may be linear or branched and optionally substituted) and mono- and poly-cyclic C₆₋₅₀aryl (optionally branched and/or substituted) and wherein R^{X3} is selected from the group consisting of C₁₋₁₂alkyl, C₂₋₁₂alkene, C₂₋₁₂alkyne (which may be linear or branched and optionally substituted) and mono- and poly-cyclic C₆₋₅₀aryl (optionally branched and/or substituted). R may be substituted by one or more groups R², independently selected from the group consisting of C₁₋₁₀alkyl, C₂₋₁₀alkene, C₂₋₁₀alkyne, C₃₋₁₀cycloalkyl, C₁₋₁₀heteroalkyl, C₁₋₁₀haloalkyl, C₆₋₁₀aryl, C₃₋₁₀heteroaryl, C₅₋₂₀heterocyclic, C₁₋₁₀alkylC₆₋₁₀aryl , C₁₋₁₀alkylC₃₋₁₀heteroaryl, C₁₋₁₀alkoxy, C₆₋₁₀aryloxy, C₃₋₁₀heteroalkoxy, C₃₋₁₀heteroaryloxy, C₁₋₁₀alkylthio, C₆₋₁₀arylthio, C₁₋₁₀heteroalkylthio, C₃₋₁₀heteroarylthio, F, Cl, Br, I, —NO₂, —CN, —CF₃, —CH₂CF₃, —CHCl₂, —OH, —CH₂OH, —CH₂CH₂OH, —NH₂, —CH₂NH₂, —NHCOH, —COOH, —ONH₂, —SO₃H, —CH₂SO₂CH₃, —PO₃H₂, —B(OR^{G1})₂, and a function -GR^{G1}, wherein G is selected from the group consisting of —O—, —S—, —NR^{G2}—, —C(═O)—, —S(═O)—, —SO₂—, —C(═O)O—, —C(═O)NR^{G2}—, —OC(═O)—, —NR^{G2}C(═O)—, —OC(═O)O—, —OC(═O)NR^{G2}—, —NR^{G2}C(═O)O—, —NR^{G2}C(═O)NR^{G2}—, —C(═S)—, —C(═S)S—, —SC(═S)—, —SC(═S)S—, —C(═NR^{G2})—, —C(═NR^{G2})O—, —C(═NR^{G2})NR^{G3}—, —OC(═NR^{G2})—, —NR^{G2}C(═NR^{G3})—, —NR^{G2}SO₂—, —NR^{G2}SO₂NR^{G3}—, —NR^{G2}C(═S)—, —SC(═S)NR^{G2}—, —NR^{G2}C(═S)S—, —NR^{G2}C(═S)NR^{G2}—, —SC(═NR^{G2})—, —C(═S)NR^{G2}—, —OC(═S)NR^{G2}—, —NR^{G2}C(═S)O—, —SC(═O)NR^{G2}—, —NR^{G2}C(═O)S—, —C(═O)S—, —SC(═O)—, —SC(═O)S—, —C(═S)O—, —OC(═S)—, —OC(═S)O— and —SO₂NR^{G2}—, wherein each occurrence of R^{G1}, R^{G2} and R^{G3} is selected, independently from the other occurrences of R^{G1}, from the group consisting of an hydrogen atom, an halogen atom, a C₁₋₁₂alkyl function, a C₁₋₁₂heteroalkyl function, a C₂₋₁₀alkene function, a C₂₋₁₀alkyne function (which may be linear, branched, or cyclic and optionally substituted), a C₆₋₁₀aryl group, a C₃₋₁₀heteroaryl group, a C₅₋₁₀heterocycle group, a C₁₋₁₀alkylC₆₋₁₀aryl group and a C₁₋₁₀alkylC₃₋₁₀heteroaryl group (in which the aryl, heteroaryl or heterocyclic radical may be substituted), or wherein, when G is —NR^{G2}—, R^{G1} and R^{G2} jointly form in common with the nitrogen atom to which they are linked a heterocycle or a heteroaryl, optionally substituted.

“Substituted” means herein, for example, the replacement in a given structure of a hydrogen radical by a radical R² as previously defined. When more than one position may be substituted, substituents may be the same or different at each position.

A “spacer ligand” means herein a ligand (including for example neutral species and ions) coordinated with at least two metals, providing the spacing between these metals and providing empty spaces or pores.

“Alkyl” means herein a carbon radical which may be linear, branched or cyclic, saturated or not, optionally substituted, and which comprises 1 to 12, preferably 1 to 10, more preferably 1 to 8, or still more preferably 1 to 6 carbon atoms.

“Alkene” means herein a radical alkyl, as hereinabove defined, having at least one double bond carbon-carbon.

“Alkyne” means herein a radical alkyl, as hereinabove defined, having at least one triple bond carbon-carbon.

“Aryl” means herein an aromatic system comprising at least one cycle which follows Nikkei's rule. Said aryl may be substituted; it may comprise 1 to 50, preferably 6 to 20, or more preferably 6 to 10 carbon atoms.

“Heteroaryl” means herein a system comprising at least one aromatic cycle comprising 5 to 50 bonds of which at least one is a heteroatom, selected for example from the group consisting of sulphur, oxygen, nitrogen and boron. Said heteroaryl may be substituted; it may comprise 1 to 50, preferably 1 to 20, or more preferably 3 to 10 carbon atoms.

“Cycloalkyl” means herein a cyclic carbonated radical, saturated or not, optionally substituted, which may comprise 3 to 20, or preferably 3 to 10 carbon atoms.

“Haloalkyl” means herein a radical alkyl, as hereinabove defined, which comprises at least one halogen.

“Heteroalkyl” means herein a radical alkyl, as hereinabove defined, which comprises at least one heteroatom, selected for example from the group consisting of sulphur, oxygen, nitrogen and boron.

‘Heterocycle” means herein a cyclic carbonated radical comprising at least one heteroatom, saturated or not, optionally substituted, which may comprise 2 to 20, preferably 5 to 20 or more preferably 5 to 10 carbon atoms. The heteroatom may be selected from the group consisting of sulphur, oxygen, nitrogen and boron.

“Alkoxy”, “aryloxy”, “heteroalkoxy” and “heteroaryloxy” mean herein, respectively, a radical alkyl, aryl, heteroalkyl and heteroaryl linked to an oxygen atom.

“Alkylthio”, “arylthio”, “heteroalkylthio” et “heteroarylthio” mean herein, respectively, a radical alkyl, aryl, heteroalkyl and heteroaryl linked to a sulphur atom.

“Schiff base” means herein a functional group comprising a double bond C═N, having the formula R^{X1}R^{X2}—C═N—R^{X3}, with R^{X1}, R^{X2} et R^{X3} as hereinabove defined.

The pores size of the MOFs suitable for the present invention may be fitted by selecting appropriate spacer ligands.

L in formula (I) of the present invention may advantageously be a di-, tri- or tetra-carboxylate ligand selected from the group consisting of C₂H₂(CO₂⁻)₂ (fumarate), C₄H₄(CO₂⁻)₂(muconate), C₅H₃S(CO₂⁻)₂ (2,5-thiophenedicarboxylate), C₆H₂N₂(CO₂)₂ (2,5-pyrazine dicarboxylate), C₂H₄(CO₂⁻)₂ succinate, C₃H₆(CO₂⁻)₂ glutarate, C₄H₈(CO₂⁻)₂ adipate, C₆H₄(CO₂⁻)₂ (terephthalate), C₁₀H₆(CO₂⁻)₂ (naphtalene-2,6-dicarboxylate), C₁₂H₈(CO₂⁻)₂ (biphenyl-4,4’-dicarboxylate), C₁₂H₈N₂(CO₂⁻)₂ (azobenzenedicarboxylate), C₆H₃(CO₂⁻)₃ (benzene-1,2,4-tricarboxylate), C₆H₃(CO₂⁻)₃ (benzene-1,3,5-tricarboxylate), C₂₄H₁₅(CO₂⁻)₃ (benzene-1,3,5-tribenzoate), C₆H₂(CO₂⁻)₄ (benzene-1,2,4,5-tetracarboxylate, C₁₀H₄(CO₂⁻)₄ (naphtalene-2,3,6,7-tetracarboxylate), C₁₀H₄(CO₂⁻)₄ (naphtalene-1,4,5,8-tetracarboxylate), C₁₂H₆(CO₂⁻)₄ (biphenyl-3,5,3′,5′-tetracarboxylate), and modified analogues (for example 2-aminoterephthalate, 2-nitroterephthalate, 2-methylterephthalate, 2-chloroterephthalate, 2-bromoterephtalate, 2,5-dihydroxoterephthalate, tetrafluoroterephthalate, 2,5-dicarboyterephthalate, dimethyl-4,4′-biphenydicarboxylate, tetramethyl-4,4′-biphenydicarboxylate, dicarboxy-4,4′-biphenydicarboxylate.

X in formula (I) of the present invention may advantageously be selected from the group consisting of OH⁻, Cl⁻, F⁻, CH₃—COO⁻, PF₆⁻, ClO₄⁻, and carboxylates selected from the group hereinabove defined.

In an alternative embodiment, MOFs of the present invention comprise various metal ions or one metal ion exhibiting various oxidation states. A single MOF may comprise a single metallic component with different valence states (e.g. V⁴⁺ and V³⁺) and/or it may comprise different metallic components (e.g. Al³⁺ and Cr³⁺).

Preferably, the MOF nanoparticles suitable for the present invention comprise a dry-phase metal percentage from 5 to 40% by weight.

Advantageously, MOFs suitable for the present invention may have a thermal stability between 120 and 400° C. MOFs suitable for the present invention are preferably stable in the presence of water or humidity.

MOFs suitable for the present invention may have a pores' size within the range 0.4 to 6 nm, preferably 0.5 to 5.2 nm, or more preferably 0.5 to 3.4 nm. They may have a specific surface area (BET) within the range 5 to 6000 m²/g, preferably 5 to 4500 m²/g. They may have a porous volume within the range 0.05 to 4 cm²/g, preferably 0.05 to 2 cm²/g.

MOF solids suitable for the present invention may have a strongly built structure, with a rigid framework, which contracts very little when pores become empty. Alternatively, they may have a flexible structure which may “breathe”, i.e. expand and contract, causing the pores' aperture to vary according to the adsorbed molecules.

“Rigid structure” means herein a structure which may breathe only very little, i.e. with an amplitude not exceeding 10%.

“Flexible structure” means herein a structure which may breathe with a large amplitude, i.e. an amplitude exceeding 10% or preferably exceeding 50%. Flexible structures may advantageously be built from chains or octahedron trimers.

MOF solids suitable for the present invention may have a flexible structure which breathes with an amplitude exceeding 10%, preferably between 50 and 300%. MOF solids having a flexible structure suitable for the present invention may have a porous volume within the range 0 to 3 cm³/g or preferably 0 to 2 cm³/g. The porous volume defines the equivalent volume accessible to solvent molecules.

In preferred embodiments of the present invention, the adsorbent comprises MOFs comprising a motif, or preferably consisting essentially of motifs, selected from the group consisting of:
A vanadium terephthalate formulated VO[C₆H₄(CO₂)₂] having a rigid structure, e.g. MIL-47, MIL-68
An aluminium or chromium terephthalate formulated M(OH)[C₆H₄(CO₂)₂] having a flexible structure, e.g. MIL-53 (M═Al, Cr)
An aluminium naphthalenedicarboxylate formulated Al(OH)[C₁₀H₆(CO₂)₂] having a flexible structure, e.g. MIL-69
An aluminium trimesate formulated Al₁₂O(OH)₁₈(H₂O)₃[C₆H₃—(CO₂)₃]₆.nH₂O having a rigid structure, e.g. MIL-96
A chromium terephthalate formulated Cr₃OX[C₆H₄(CO₂)₂]₃ having a flexible structure, e.g. MIL-88B
A chromium biphenyldicarboxylate formulated Cr₃OX[C₁₂H₈(CO₂)₂]₃ having a flexible structure, e.g. MIL-88D
A chromium trimesate formulated Cr₃OX[C₆H₃(CO₂)₃]₃ having a rigid structure, e.g. MIL-100(Cr)
A vanadium trimesate formulated V₃OX[C₆H₃(CO₂)₃]₃, having a rigid structure, e.g. MIL-100(V)
A zirconium terephthalate formulated ZrO[C₆H₄(CO₂)₂] having a rigid structure, e.g. ZrMOF
A chromium terephthalate Cr₃OX[C₆H₄(CO₂)₂]₃ having a rigid structure, e.g. MIL-101
An aluminium trimesate formulated Al₈(OH)₁₅(H₂O)₃[C₆H₃(CO₂)₃]₃ having a rigid structure, e.g. MIL-110
A titanium(IV) terephthalate formulated Ti₈O₈(OH)₄[O₂C—C₆H₄—CO₂]₆ having a rigid structure, e.g. MIL-125
A titanium(IV) 2-aminoterephthalate formulated Ti₈O₈(OH)₄[O₂C—C₆H₃(NH₂)—CO₂]₆ having a rigid structure, e.g. MIL-125(NH₂)
   wherein X is as hereinabove defined

(MIL=Materiaux Institut Lavoisier)

Synthesis and characterisation of these materials are given in Annex 1, which is part of the present description.

Preferably, the adsorbent of the invention may be regenerated and used again in a method for separating a sulphur compound according to the present invention. This may provide a multi-use gas adsorber, i.e. which may be subjected to various cycles of adsorption and regeneration.

In order to ensure that the adsorbent may be regenerated and used again, whilst the inventors should not be bound by theory, one hypothesis is that the MOF structure should not have a metallic centre which is accessible (i.e. which is not saturated), i.e. the MOF should not comprise a complexation site available on metal M.

It is believed that both the nature of metal M and the MOF structure are important to obtain an adsorbent according to the present invention. We have found, for example, that:
when using iron or zinc as metal ion, whatever the spacer ligand is, the MOF porous structures are destroyed in the presence of a sulphur compound. This is probably due to the formation of FeS or ZnS;
when using chromium as metal ion and using the MOF structure of e.g. MIL-53, i.e. a structure which does not have a non-saturated metallic centre, an adsorbent according to the present invention is obtained, which may be regenerated and used again;
when using chromium as metal ion and using the MOF structure of e.g. MIL-101, i.e. a structure which has the same spacer ligand as MIL-53 but which has a non-saturated metallic centre, an adsorbent is obtained, which may not be efficiently regenerated and used again.

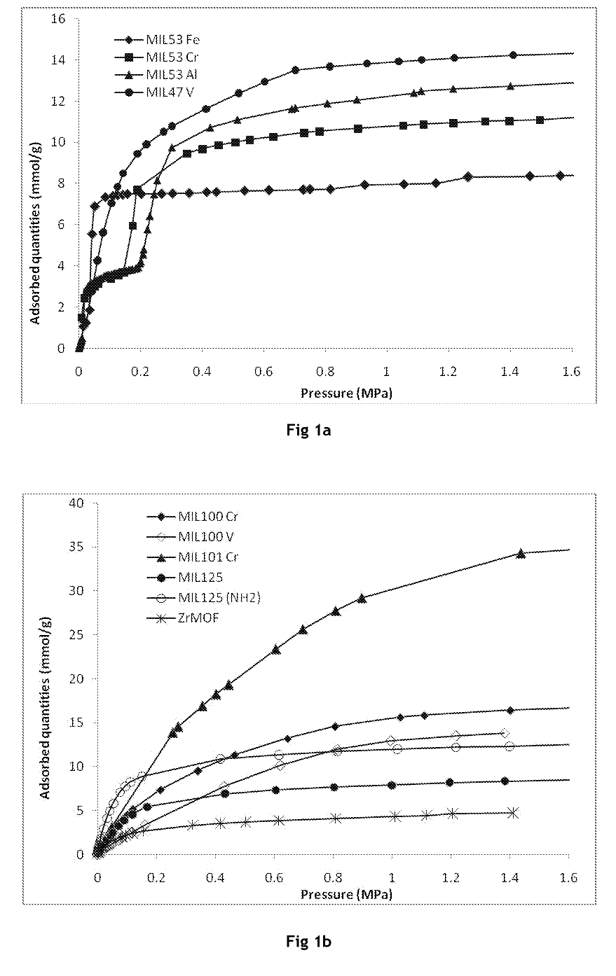

Embodiments of the invention will now be further described, by way of example only, with reference to FIGS. 1 to 64 and to examples 1 to 9, together with comparative examples 1 and 2.

FIGS. 1a and 1b show the adsorbed quantities of hydrogen sulphide on MIL-47(V⁴⁺), MIL-53(Al), MIL-53(Cr), MIL-53(Fe), MIL-100(Cr), MIL-100(V³⁺), MIL-101(Cr), MIL-125, MIL-125(NH₂) and ZrMOF at 30° C., at pressures up to 1.4 MPa (see examples for more detailed explanations).

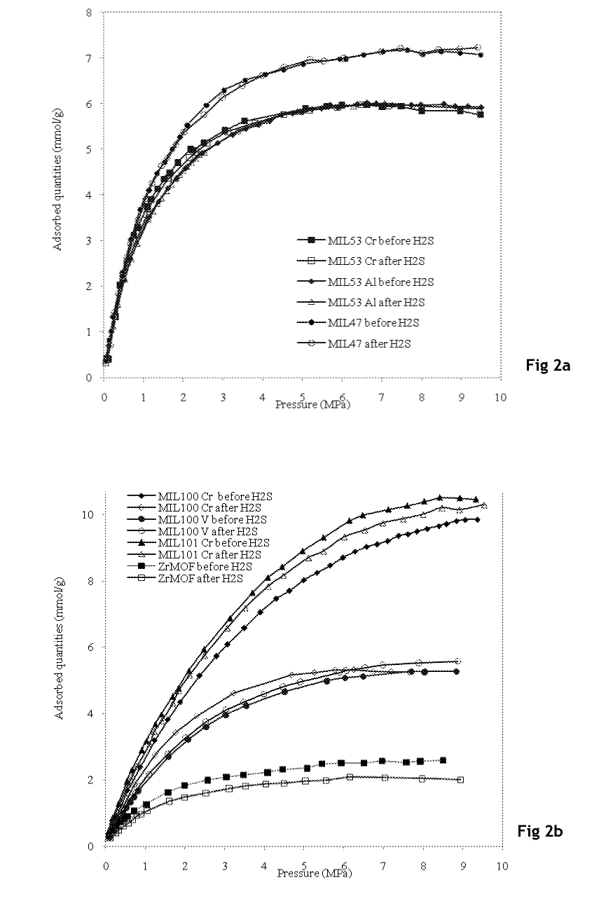

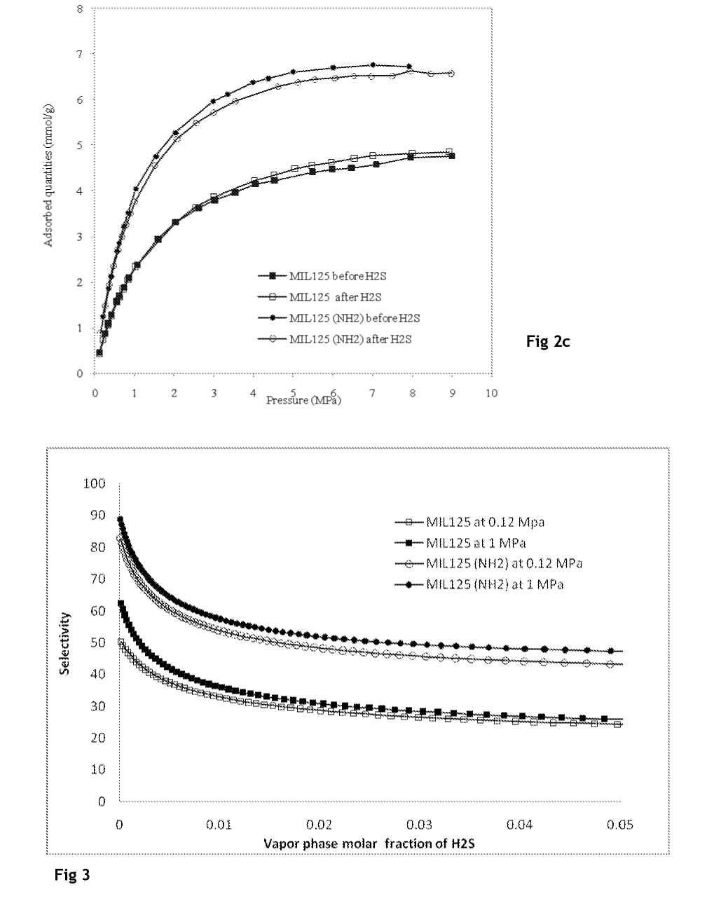

FIGS. 2a, 2b and 2c show the adsorbed quantities of methane on MIL-47(V⁴⁺), MIL-53(Al), MIL-53(Cr), MIL-100(Cr), MIL-100(V³⁺), MIL-101(Cr), ZrMOF, MIL-125 and MIL-125(NH₂) before and after an adsorption of H₂S at 30° C. (the H₂S tests were performed in particularly very hard conditions (isotherm up to 1 MPa), which is far more severe than the usual industrial range of sulphur compound partial pressure) and a regeneration treatment under primary vacuum at temperature ranging from 120° C. to 200° C. (see examples for more detailed explanations).

FIG. 3 shows the selectivity of H₂S/CH₄ on MIL-125 and MIL-125(NH₂).

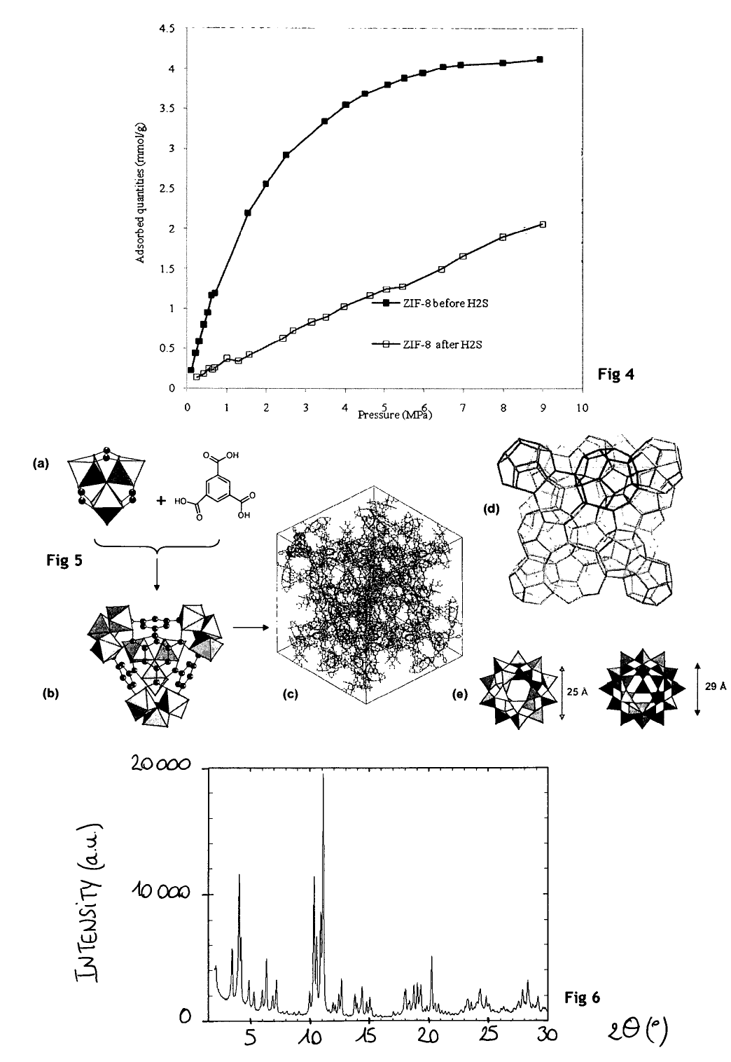

FIG. 4 shows the adsorbed quantities of methane on ZIF-8 before and after an adsorption of H₂S at 30° C. and a regeneration treatment under primary vacuum (see comparative example 2 for more detailed explanations).

FIGS. 5 to 64 show crystal structures and graphs to illustrate the synthesis and characterisation of preferred MOFs suitable for the present invention, as described in Annex 1.

### EXAMPLE 1

1 g of MIL-53(Cr) is contacted, at 30° C. and at various pressures, with a gas mixture consisting essentially of hydrogen sulphide and methane and its adsorption characteristics are measured. The adsorbed quantity of H₂S on MIL-53(Cr) is shown in FIG. 1a. MIL-53(Cr) has good adsorption properties, high selectivity and is stable (i.e. chemically resistant to sulphur compounds). MIL-53(Cr) may be regenerated: for example, after a vacuum treatment of 8 hours at 120° C., MIL-53(Cr) recovers its initial weight and shows a similar adsorption ability as before the first adsorption of H₂S (see FIG. 2a).

### EXAMPLE 2

MIL-53(Al) is contacted, under the same conditions as in example 1, with a mixture of hydrogen sulphide and methane. The adsorbed quantity of H₂S on MIL-53(Al) is shown in FIG. 1a. MIL-53(Al) has good adsorption properties, high selectivity and is stable. MIL-53(Al) may be regenerated: for example, after a vacuum treatment of 8 hours at 120° C., MIL-53(Al) recovers its initial weight and shows a quasi-identical adsorption ability as before the first adsorption of H₂S (see FIG. 2a).

### EXAMPLE 3

MIL-47(V⁴⁺) is contacted, under the same conditions as in example 1, with a mixture of hydrogen sulphide and methane. The adsorbed quantity of H₂S on MIL-47(V⁴⁺) is shown in FIG. 1a. MIL-47(V⁴⁺) has good adsorption properties, high selectivity and is stable. MIL-47(V⁴⁺) may be regenerated: for example, after a vacuum treatment of 8 hours at 200° C. MIL-47(V⁴⁺) recovers its initial weight and shows a quasi-identical adsorption ability as before the first adsorption of H₂S (see FIG. 2a).

### EXAMPLE 4

MIL-100(Cr) is contacted, under the same conditions as in example 1, with a mixture of hydrogen sulphide and methane. The adsorbed quantity of H₂S on MIL-100(Cr) is shown in FIG. 1b. MIL-100(Cr) has very high adsorption properties, high selectivity and is stable. However, MIL-100(Cr) may not be regenerated efficiently: for example, after a vacuum treatment of 8 hours at 150° C., MIL-100(Cr) does not recover its initial weight or adsorption characteristics for H₂S (see FIG. 2b).

### EXAMPLE 5

MIL-100(V³⁺) is contacted, under the same conditions as in example 1, with a mixture of hydrogen sulphide and methane. The adsorbed quantity of H₂S on MIL-100(V³⁺) is shown in FIG. 1b. MIL-100(V³⁺) has very high adsorption properties, high selectivity and is stable. MIL-100(V³⁺) may be regenerated efficiently: for example, after a vacuum treatment of 8 hours at 200° C., MIL-100(V³⁺) recovers its initial weight and shows a similar adsorption ability as before the first adsorption of H₂S (see FIG. 2b).

### EXAMPLE 6

ZrMOF is contacted, under the same conditions as in example 1, with a mixture of hydrogen sulphide and methane. The adsorbed quantity of H₂S on ZrMOF is shown in FIG. 1b. ZrMOF is stable and has adsorption properties and selectivity, but lower than those of the other examples. ZrMOF may be regenerated but not as efficiently as e.g. MIL-53(Al): for example, after a vacuum treatment of 8 hours at 200° C., ZrMOF does not completely recover its initial weight or adsorption characteristics for H₂S (see FIG. 2b).

### EXAMPLE 7

MIL-101(Cr) is contacted, under the same conditions as in example 1, with a mixture of hydrogen sulphide and methane. The adsorbed quantity of H₂S on MIL-101(Cr) is shown in FIG. 1b. MIL-101(Cr) has very high adsorption properties, high selectivity and is stable. MIL-101(Cr) may be regenerated but does not totally recover its initial weight after a regenerative treatment as described in example 1; it shows similar, but not identical, adsorption characteristics as those obtained before the first adsorption of H₂S (see FIG. 2b).

### EXAMPLE 8

MIL-125 is contacted, under the same conditions as in example 1, with a mixture of hydrogen sulphide and methane. The adsorbed quantity of H₂S on MIL-125 is shown in FIG. 1b. MIL-125 has good adsorption properties, high selectivity and is stable. MIL-125 may be regenerated efficiently: for example, after a vacuum treatment of 8 hours at 200° C., MIL-125 recovers its initial weight and shows a similar adsorption ability as before the first adsorption of H₂S (see FIG. 2c).

### EXAMPLE 9

MIL-125 (NH₂) is contacted, under the same conditions as in example 1, with a mixture of hydrogen sulphide and methane. The adsorbed quantity of H₂S on MIL-125(NH₂) is shown in FIG. 1b. MIL-125(NH₂) has very good adsorption properties, high selectivity and is stable.

The adsorption ability and the selectivity are increased (more than 50% for adsorption and more than 80% for selectivity) in comparison with MIL125 by using modified analogue ligands (i.e. 2-aminoterephhalate instead of terephthalate) (see FIG. 3). MIL-125 (NH₂) can be regenerated efficiently: for example, after a vacuum treatment of 8 hours at 200° C., MIL-125(NH₂) recovers its initial weight and shows a similar adsorption ability as before the first adsorption of H₂S (see FIG. 2c).

### Comparative Example 1 (Not in Accordance with the Present Invention)

When MIL-53(Fe) is contacted, under the same conditions as in the previous examples, with a mixture of hydrogen sulphide and methane, the MOF is destroyed. MIL-53(Fe) does not meet the requirement of stability of a MOF suitable for the present invention.

### Comparative Eexample 2 (Not in Accordance with the Present Invention)

ZIF-8 (Zn²) is contacted, under the same conditions as in example 1, with a mixture of hydrogen sulphide and methane. ZIF-8 has good adsorption properties and good selectivity; it is generally well known, in the literature, for its stability. However, ZIF-8 may not be regenerated efficiently: for example, after a vacuum treatment of 8 hours at 200° C., ZIF-8 does not recover its initial weight or adsorption characteristics with H₂S (see FIG. 4). The MOF is damaged. ZIF-8 does not meet the requirement of stability of a MOF suitable for the present invention.

### Annex 1

### Synthesis and Characterisation of Preferred MOFs Suitable for the Present Invention

### 1. MIL-100(Cr)

### 1.1. Crystal Structure

MIL100(Cr) crystallises in the cubic space group Fd-3m (n° 227) with a-72.9 Å. Its structure is built up from trimers of chromium(III) octahedra connected through 1,3,5 benzenetricarboxylate groups. This leads to the formation of giant hybrid supertetrahedra (ST's) which are connected to produce a porous hybrid solid with a zeotype architecture of the MTN or ZSM-39 structure type. Two kinds of mesoporous cages are present, built up from 20 and 28 ST's, respectively, with free aperture of ca. 24 and 29 Å. These cages are accessible though microporous pentagonal or hexagonal windows of free aperture of 4.8*5.8 Å or 8.6*8.6 Å, respectively.

FIG. 5 shows: (a) trimers of chromium octahedra and trimesate moities; (b) hybrid supertetrahedron; (c) one unit cell of MIL-100; (d): schematic view of the zeotypic structure of MIL-100; (e) schematic representation of the two mesoporous cages of MIL-100.

### 1.2. Standard Synthesis Procedure

100 mg of chromium(VI) oxide CrO₃, 210 mg of trimesic acid, 0.2 ml of a 5 M hydrofluorohydric solution and 4.8 ml of deionized water were added and stirred a few minutes at room temperature. The slurry was then introduced in a Teflon-line Paar hydrothermal bomb and set four days at 220° C. (heating ramp of 12 hours). The resulting green solid was washed with deionized water and acetone and dried at room temperature under air atmosphere. In order to get rid of traces of trimesic acid outside and inside the pores, the solid was further dispersed in 100 ml of deionised water and stirred 3 hours at 80° C. After cooling and filtration, the solid was finally dried at room temperature under air atmosphere. The final solid exhibits the following formula: Cr₃(H₂O)₂OF[C₆H₄—(CO₂)₃].nH₂O (n-28).

### 1.3. X-Ray Diffraction Pattern of the As-Made Material

FIG. 6 shows: X-Ray diffraction pattern of MIL-100(Cr) (λ_{Cu}=1.5406 Å)

### 1.4. TGA Analysis

FIG. 7 shows: TGA of MIL-100(Cr) under air atmosphere (heating ramp: 3° C./minute)

Please note that the water content, which varies from 15 up to 50%, strongly depends on the atmospheric conditions.

### 1.5. X-Ray Thermodiffractometry

FIG. 8 shows: X-Ray thermodiffractometry of MIL-100(Cr) under vacuum (10⁻² Torr) (λ_{Cu}=1.5406 Å)

1.6 Nitrogen isotherm at 77 K

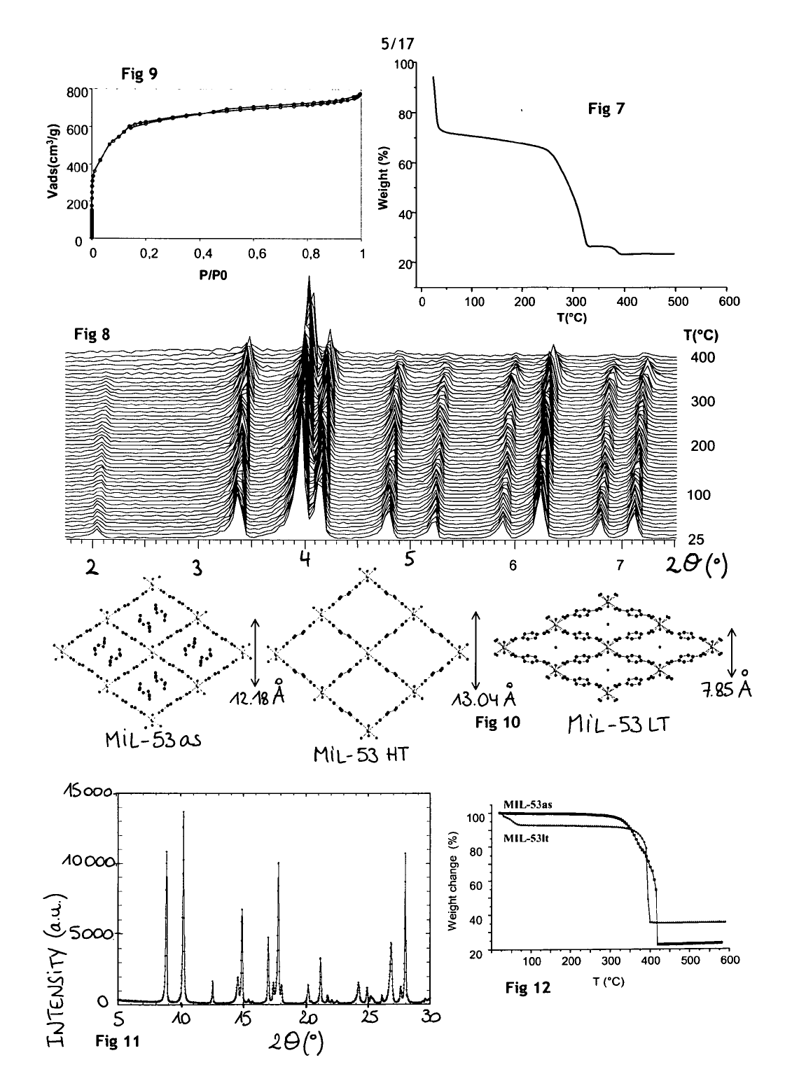

FIG. 9 shows: N₂ adsorption-desorption isotherm of MIL-100(Cr) at 77 K (P₀=1 atm.) (Outgassing conditions: 150° C. overnight under vacuum).

### 2. MIL53(Cr)

### 2.1 Crystal Structure

MIL-53as, MIL-53ht and MIL-531t (as: as-synthesised; ht: high temperature; lt: low temperature) exhibit a three-dimensional structure built-up from chromium(III) octahedra and terephthalate ions creating a three-dimensional framework with a 1-d pore channel system of ca. 8.5 A free aperture (see FIG. 10). Pores of MIL-53as or Cr^{III}(OH).{O₂C—C₆H₄—CO₂}.{HO₂C—C₆H₄—CO₂H}_{0.75} are filled with disordered free terephthalic acid, which can be removed by calcination to give MIL-53ht or Cr^{III}(OH).{O₂C—C₆H₄—CO₂}. This latter hydrates at room temperature to give MIL-531t or Cr^{III}(OH).{O₂C—C₆H₄—CO₂}.H₂O; the water molecules are located at the centre of the pores, strongly interacting through hydrogen bonds with oxygen atoms or hydroxyl groups of the inorganic network. Crystal data for MIL-53as: orthorhombic space group Pnam with a=17.340(1) Å, b=12.178(1) Å, c=6.822(1) Å and Z=4. Crystal data for MIL-53ht: orthorhombic space group Imcm with a=16.733(1) Å, b=13.038(1) Å, c=6.812(1) Å, and Z=4. Crystal data for MIL-531t: monoclinic space group C2/c with a=19.685(4) Å, b=7.849(1) Å, c=6.782(1) Å, □=104.90(1)° and Z=4.

FIG. 10 shows: View of the structures of MIL-53as, MIL-53ht and MIL-531t along the c axis.

### 2.2. Standard Synthesis Procedure

MIL-53(Cr)as or Cr(OH)[O₂C—C₆H₄—CO₂].x(HO₂C—C₆H₄—CO₂H) (x-0.75) was synthesized starting from three grams of Cr(NO₃)₃.xH₂O, 1.5 ml of 5 Mol.l-1 solution of hydrofluorhydric acid, 1.9 g of terephthalic acid and 25 ml of deionised water, introduced in a 125 ml Teflon-lined steel autoclave and the temperature set at 493 K for four days. A light purple powder was obtained together with traces of terephthalic acid.

### 2.3. X-Ray Diffraction Pattern of the As-Made Material

FIG. 11 shows: X-Ray diffraction pattern of MIL-53(Cr) as-synthesised (λ_{Cu}=1.5406 Å)

### 2.4. TGA Analysis

FIG. 12 shows: TGA of MIL-53(Cr)as and MIL-53(Cr)_{LT} under air atmosphere (heating ramp: 3° C./minute)

### 2.5. Activation Protocol for This Material

1st way: calcination of 300 mg of MIL-53(Cr) is performed at 300° C. in a alumina crucible under air atmosphere during 24 hours. Note that the calcination time is strongly dependent on the amount of solid treated.

2d way: an alternative procedure for removing the free terephthalic acid from the pores of MIL-53(Cr) is the following : 300 mg of MIL-53as is dispersed into 5 ml of Dimethylformamide in a 23 ml Teflon Liner, and then introduced in a metallic Paar Bomb. The Bomb is then introduced into an oven at 150° C. overnight. After cooling and filtration, the solid is then calcined overnight at 200° C. under air atmosphere, in order to remove the DMF from the pores.

In both cases, after cooling, MIL-53HT (HT: High Temperature) rehydrates to give the MIL-53LT form or Cr(OH)[O₂C—C₆H₄—CO₂].H₂O (LT: Low Temperature).

### 2.6. X-Ray Diffraction Pattern of the Calcined Material

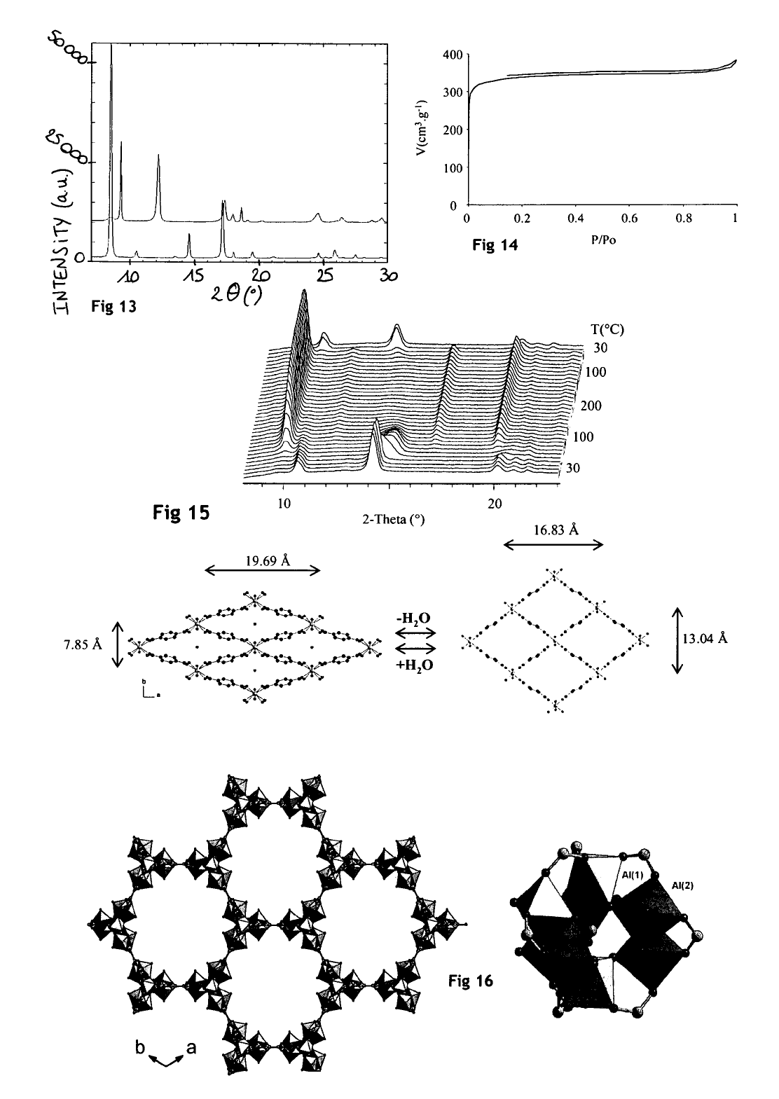

FIG. 13 shows: X-Ray diffraction patterns of MIL-53(Cr)_{HT} (below) and MIL-53(Cr)_{LT} (above) (λ_{Cu}−1.5406 Å)

### 2.7 Nitrogen Isotherm at 77 K for the Calcined Material

FIG. 14 shows: N₂ adsorption-desorption isotherm of MIL-53(Cr)_{HT} at 77 K (P₀=1 atm.) (Outgassing conditions: 200° C. overnight under vacuum)

### 2.8 MIL53(Cr): A Breathing Solid

FIG. 15 shows: Schematic representation of the reversible hydration-dehydration of MIL-53_{LT} and MIL-53_{HT}. X-Ray thermodiffractogram (λ_{Co}−1.79 Å) of MIL-53_{LT} under air; for a better understanding, a 2θ offset is applied for each pattern

### 3. MIL-110(Al)

### 3.1. Crystal Structure

MIL-110 exhibits a three-dimensional structure built-up from inorganic clusters containing eight aluminum(III) octahedra and 1,3,5-benzenetricarboxylate anions creating a three-dimensional framework with a 1-d pore hexagonal channel system of ca. 16 Å free aperture (see FIG. 16). Pores of MIL-110 or Al₈(OH)₁₅(H₂O)₃[C₆H₃(CO₂)₃]₃ are filled with free water molecules, nitrate anions and trimesate species located at the centre of the pores, strongly interacting through hydrogen bonds with oxygen atoms or hydroxyl groups of the inorganic network. Crystal data for MIL-110(Al): hexagonal space group P-62c with a=b=21.520(5) Å, c=13.021 (1) Å and Z=4.

FIG. 16 shows: View of the structure of MIL-110 showing the hexagonal channels running along c (left) and the inorganic octameric cluster with eight Al-centered octahedra with edge- and corner sharing (right).

### 3.2. Standard Synthesis Procedure

The synthesis of MIL-110 (Al) was previously described in Nature Materials 6 760 (2007). The compound MIL-110 was hydrothermally synthesized from a mixture containing aluminum nitrate (Al(NO₃)₃ 9H₂O, Aldrich 98%), trimethyl 1,3,5-benzenetricarboxylate (C₆H₃(CO₂CH₃)₃, 98%, Aldrich, noted Me₃btc), concentrated nitric acid (HNO₃) 4M and deionized water. The molar composition was 1.5 Al (0.6659 g, 1.8 mmol), 1 Me₃btc (0.3025 g mg, 1.2 mmol), 3.3 HNO₃ (1 ml, 4.0 mmol) and 226 H₂O (5 ml, 277.8 mmol). The MIL-110 phase is obtained in very acidic condition (pH≈0) by adding concentrated nitric acid. The starting mixture was placed in a Teflon cell, which was heated in a steel Parr autoclave for 72 hours at 210° C. The resulting powdered pale yellow product was filtered off, washed with deionized water and dried in air at room temperature and was first identified by powder X-ray diffraction. Optical microscope analysis indicated that the sample is composed of elongated needle-like crystals with 5-30 μm long. The SEM micrographs show hexagonal shapes (0.5-2 μm diameter) of the rod-like crystals.

### 3.3. X-Ray Diffraction Pattern of the As-Made Material

FIG. 17 shows: X-Ray diffraction pattern of MIL-110(Al) as-synthesised (λ_{Cu}=1.5406 Å)

### 3.4. TGA Analysis

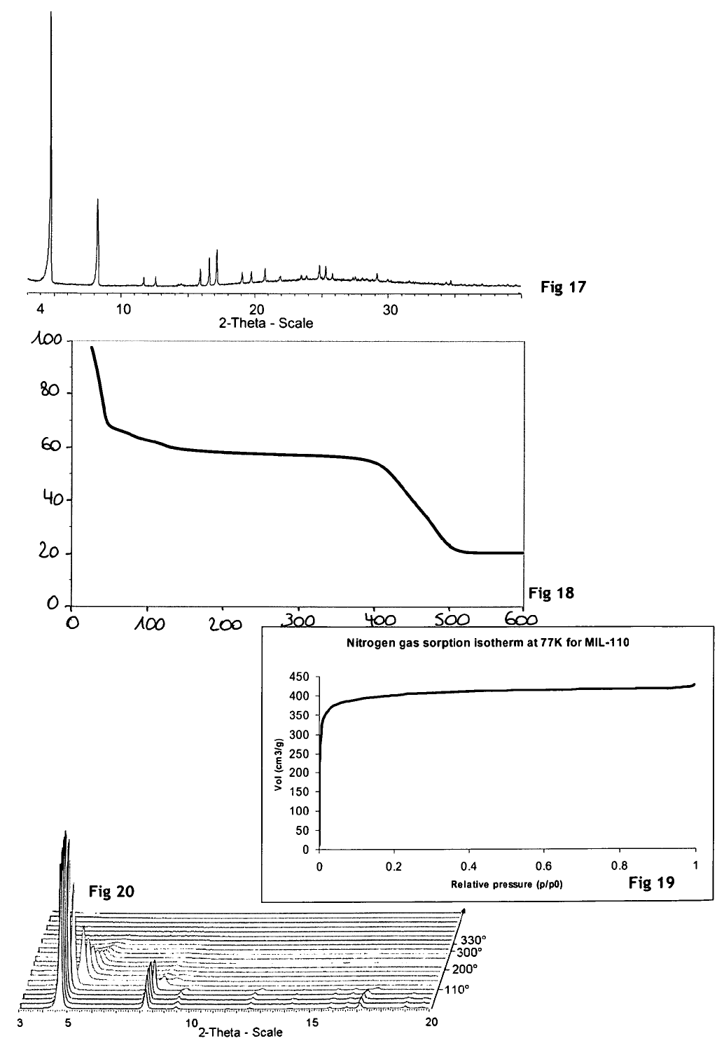

FIG. 18 shows: TGA of MIL-110(Al) (heating ramp: 1° C./minute)

### 3.5. Nitrogen Isotherm at 77 K for the Activated Material

The nitrogen sorption experiment on the activated MIL-110 (degassed at 85° C. overnight) revealed a type I isotherm without hysteresis upon desorption, which is characteristic of a microporous solid. The measured BET surface area is 1408(27) m².g⁻¹ with a micropore volume of 0.58 cm³.g⁻¹ and assuming a monolayer coverage by nitrogen, the Langmuir surface area is 1792(3) m².g⁻¹.

FIG. 19 shows: N2 adsorption-desorption isotherm of MIL-110(Al) at 77 K (P₀=1 atm.) (Outgassing conditions: 85° C. overnight under vacuum)

### 3.6. Activation Protocol for This Material

Preliminary thermogravimetric and chemical analyses indicated that the as-synthesized MIL-110 compound contained a significant amount of non reactive trimesate and nitrate species which are assumed to be trapped within the channels. The solid was activated with the following procedure in order to remove the encapsulated species: 0.2 g of a MIL-110 sample was placed in 60 ml methanol (hplc grade 99.9% Aldrich) for 6 hours in a Teflon-lined steel Parr autoclave heated at 100° C. The powdered product was then filtered off, mixed with water for 5 hours and finally filtered off.

### 3.7. X-Ray Thermodiffractometry

FIG. 20 shows: X-Ray thermodiffractometry of MIL-110(Al) under air (λ_{Cu}−1.54 Å)

### 4. MIL88B(Cr)

### 4.1 Crystal Structure

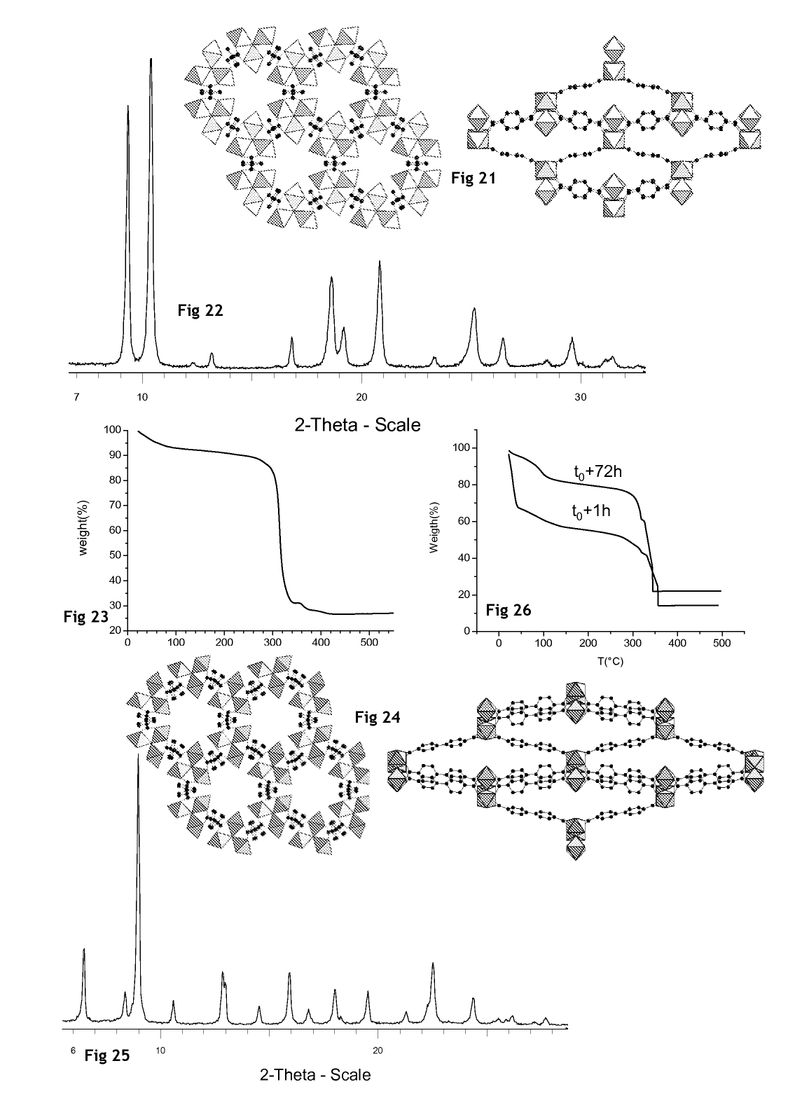

MIL-88B is built up from oxo-centered trinuclear chromium(III) units and dicarboxylates linkers (ref: Suzy Surblé, Christian Serre, Caroline Mellot-Draznieks, Franck Millange, and Gérard Férey: Chem. Comm. 2006 284-286) The trimers of octahedra are related together by trans, trans dicarboxylate moieties ensuring the three-dimensionality of the framework (FIG. 21). Chromium atoms exhibit an octahedral environment with four oxygen atoms of the bidendate dicarboxylates, one μ₃O atom and one oxygen atom from either a terminal water molecule or a F group. Octahedra are related through the μ₃O oxygen atom to form the trimeric building units. Two types of pores are present. First, narrow hexagonal channels run along the c axis filled with either water/pyridine. These hexagonal channels are delimited by six trimers whose vertexes are the central μ₃O atoms; the free aperture of the channels is rather small (˜2-4 Å). The second pore system consists of bipyramidal cages, the equatorial plane of which is (001) and the axis the c parameter.

Crystal data for MIL-88B: hexagonal space group P-62c (n° 190) with a=11.028(1) Å, c=18.972(1) Å and Z=2.

FIG. 21 shows: View of the structure of MIL-88B. Left: along the c axis; right: view of the cages.

### 4.2. Standard Synthesis Procedure

MIL-88B(Cr) or Cr₃^{III}OX.{O₂C—C₆H₄—CO₂}₃.8H₂O.C₅H₆N was synthesized starting from 400 mg of Cr(NO₃)₃.xH₂O, 0.2 ml of 5 Mol.l-1 solution of hydrofluorhydric acid, 164 mg of terephthalic acid, 2.5 ml of deionised water and 2.5 ml of pyridine (Aldrich, 99%), introduced in a 25 ml Teflon-lined steel autoclave and the temperature set at 493 K for 15 hours. A light green powder was obtained together with traces of terephthalic acid. The title solid was calcined overnight at 200° C. under air and rehydration occured slowly when back to room temperature.

### 4.3. X-Ray Diffraction Pattern

FIG. 22 shows: X-Ray diffraction pattern of MIL-88B(Cr) (λ_{Cu}=1.5406 Å)

### 4.4. TGA Analysis

FIG. 23 shows: TGA of MIL-88B(Cr) under air atmosphere (heating ramp: 3° C./minute).

MIL-88B does not exhibits any nitrogen sorption capacity at 77 K (P₀=1 atm.) (Outgassing conditions: 200° C. overnight under vacuum)

### 5. MIL88D(Cr)

### 5.1 Crystal Structure

MIL-88D or Cr₃^{III}OF{O₂C—C₁₂H₈—CO₂}₃.24H₂O.2.5C₅H₆N is built up from oxo-centered trinuclear chromium(III) units and dicarboxylates linkers (ref: Suzy Surblé, Christian Serre, Caroline Mellot-Draznieks, Franck Millange, and Gérard Férey: Chem. Comm. 2006 284-286). The trimers of octahedra are related together by trans, trans dicarboxylate moieties ensuring the three-dimensionality of the framework (see FIG. 24). Chromium atoms exhibit an octahedral environment with four oxygen atoms of the bidendate dicarboxylates, one μ₃O atom and one oxygen atom from either a terminal water molecule or a F group. Octahedra are related through the μ₃O oxygen atom to form the trimeric building units. Two types of pores are present. First, narrow hexagonal channels run along the c axis filled with either water/pyridine. These hexagonal channels are delimited by six trimers whose vertexes are the central μ₃O atoms; the free aperture of the channels is rather small (˜2-4 Å). The second pore system consists of bipyramidal cages, the equatorial plane of which is (001) and the axis the c parameter. Crystal data for MIL-88D: hexagonal space group P-62c (n° 190) with a=12.165(1) Å, c=27.191(1) Å and Z=2.

FIG. 24 shows: View of the structure of MIL-88D. Left: along the c axis; right: view of the cages.

### 5.2. Standard Synthesis Procedure

MIL-88D(Cr) or Cr₃OF(H₂O)₂[O₂C—C₆H₄—CO₂]₃.xpyridine.nH₂O (x-0.75; n-6) was synthesized starting from 400 mg of Cr(NO₃)₃.xH₂O, 0.2 ml of 5 Mol.l-1 solution of hydrofluorhydric acid, 164 mg of 4,4′ biphenyl dicarboxylic acid, 2.5 ml of deionised water and 2.5 ml of pyridine (Aldrich, 99%), introduced in a 25 ml Teflon-lined steel autoclave and the temperature set at 493 K for 15 hours. A light green powder was obtained together with traces of terephthalic acid. The title solid was dried under air at room temperature.

### 5.3. X-Ray Diffraction Pattern

FIG. 25 shows: X-Ray diffraction pattern of MIL-88D(Cr) (λ_{Cu}=1.5406 Å)

### 5.4. TGA Analysis

FIG. 26 shows: TGA of MIL-88D(Cr) under air atmosphere (heating ramp: 3° C./minute). Below: after one hour of drying at room temperature; Above: after three days of drying at room temperature

MIL-88D does not exhibit any nitrogen sorption capacity at 77 K (P₀=1 atm.) (Outgassing conditions: 200° C. overnight under vacuum)

### 6. MIL-101(Cr)

### 6.1. Crystal Structure

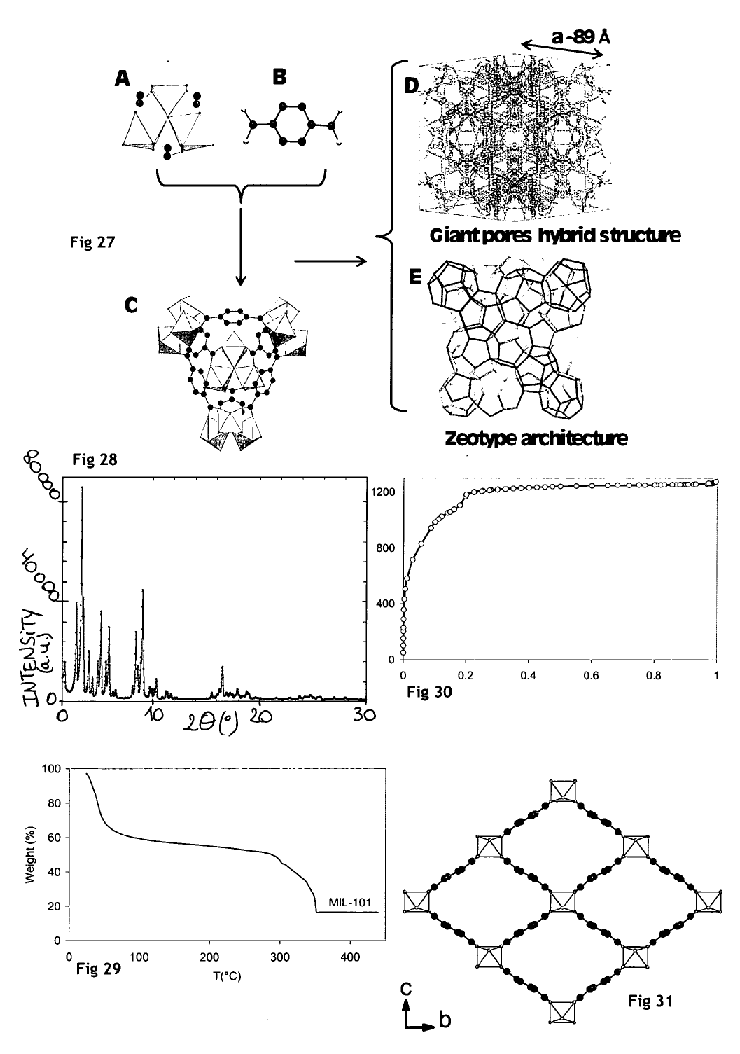

MIL-101(Cr) is made from the linkage of 1,4-BDC anions and inorganic trimers that consist in three chromium atoms in an octahedral environment with four oxygen atoms of the bidendate dicarboxylates, one μ₃O atom and one oxygen atom from the terminal water or fluorine group (ref: Gérard FEREY, Caroline MELLOT-DRAZNIEKS, Christian SERRE, Franck MILLANGE, Julien DUTOUR, Suzy SURBLE, Irena MARGIOLAKI: Science 2005 309, 2040). Octahedra are related through the μ₃O oxygen atom to form the trimeric building unit. The four vertices of the ST are occupied by the trimers while the organic linkers are located at the six edges of the ST. The STs are microporous (−8.6 Å free aperture for the windows) while the resulting framework delimits two types of mesoporous cages filled with guest molecules (see FIG. 27). These two cages, which are present in a 2:1 ratio, are delimited by 20 and 28 ST with an internal free diameter of −29 Å and 34 Å, respectively (see FIG. 27). Indeed, the smallest cages exhibit pentagonal windows with a free opening of −12 Å, while the larger cages possess both pentagonal and larger hexagonal windows of a −14.5 Å×16 Å free aperture. Crystal data for MIL-101(Cr)as: cubic space group Fd-3m with a=88.9(2) Å.

FIG. 27 shows: (A): trimer of chromium octahedral; (B) terephthalate linker; (C) hybrid supertetrahedron; (D) one unit cell of MIL-101; (E): schematic view of the zeotypic structure of MIL-101.

### 6.2. Standard Synthesis Procedure

A typical synthesis involves a solution containing chromium(III) nitrate Cr(NO₃)₃.9H₂O (400 mg, 1.10-3 mol (Aldrich, 99%)), 1.10-3 mol of fluorhydric acid, 1,4-benzene dicarboxylic acid H₂BDC (164 mg, 1.10-3 mol (Aldrich 99%)) in 4.8 ml H₂O (265.10-3 mol); the mixture is introduced in a hydrothermal bomb which is put during 8 h in an autoclave held at 220° C.

After natural cooling, a significant amount of recristallised terephthalic acid is present. To eliminate most of the carboxylic acid, the mixture is filtered first using a large pore fritted glass filter (n° 2); the water and the MIL-101 powder passes through the filter while the free acid stays inside the glass filter. Then, the free terephthalic acid is eliminated and the MIL-101 powder is separated from the solution using a small pores (n° 5) paper filter and blichner. The yield of the reaction is ≈50% based on chromium.

### 6.3. X-Ray Diffraction Pattern of the As-Made Material

FIG. 28 shows: X-Ray diffraction pattern of MIL-101(Cr) as-synthesised (λ_{Cu}=1.5406 Å)

### 6.4. TGA Analysis

FIG. 29: TGA of MIL-101(Cr)as under air atmosphere (heating ramp: 5° C./minute)

### 6.5. Activation Protocol for This Material

An activation route was developped for removing the unreacted terephthalate species encapsulated within the pores of the 3D framework. To avoid this, the as-synthesized MIL-101 was further purified by the following two-step processes using hot ethanol and aqueous NH₄F solutions. The crystalline MIL-101 product in the solution was doubly filtered off using two glass filters with a pore size between 40 and 100 μm to remove the free terephthalic acid. Then a solvothermal treatment was sequentially performed using ethanol (95% EtOH with 5% water) at 353 K for 24 h. The resulting solid was soaked in 1 M of NH₄F solution at 70° C. for 24 h and immediately filtered, washed with hot water. The solid was finally dried overnight at 423 K under air atmosphere.

### 6.6. Nitrogen Isotherm at 77 K for the Activated Material

FIG. 30 shows: N₂ adsorption-desorption isotherm of MIL-53(Al)_{HT} at 77 K (P₀=1 atm.) (Outgassing conditions: 200° C. overnight under vacuum)

### 7. MIL-53(Al)

### 7.1. Crystal Structure

The aluminum MIL-53(Al) solid exhibits the same structure and the same breathing behavior as the chromium analogue MIL-53(Cr). The only difference concerns its cell parameters which are slightly smaller than the Cr phase. Crystal data for MIL-53(Al)as: orthorhombic space group Pnma with a=17.129(2) Å, b=6.628(1) Å, c=12.182(1) A and Z=4. Crystal data for MIL-53(Al)ht: orthorhombic space group Imma with a=6.608(1) Å, b=16.675(3) Å, c=12.813(2) Å, and Z=4. Crystal data for MIL-531t: monoclinic space group Cc with a=19.513(2) Å, b=7.612(1) Å, c=6.576(1) Å, □=104.24(1)° and Z=4.

FIG. 31 shows: structure of MIL-53(Al)ht

### 7.2. Standard Synthesis Procedure

The synthesis was carried out under mild hydrothermal conditions using aluminum nitrate nonahydrate (Al(NO₃)₃.9H₂O, 98+%, Aldrich), 1,4-BenzeneDiCarboxylic acid (C₆H₄-1,4-(CO₂H)₂>98%, Merck, noted BDC hereafter) and de-ionized water. The reaction was performed in a 23 ml Teflon-lined stainless steel Parr bomb under autogenous pressure for 3 days at 220° C. The molar composition of the starting gels was: 1 Al (1.30 g): 0.5 BDC (0.288 g): 80 H₂O. After filtering off and washing with de-ionized water, the resulting white product was first identified by powder X-ray diffraction. It consists of a mixture of the as-synthesized MIL-53(Al)as (Al(_{OH})[O₂C—C₆H—CO₂].[HO₂C—C₆H₄—CO₂H]_{0.70}) and unreacted BDC acid (easily identified by large needle-shaped crystallites). The solid was purified upon heating in air (330° C., 3 days). At this temperature, the unreacted BDC species and the occluded BDC molecules contained in the structure are evacuated and this leads to MIL-53(Al)HT or Al(OH)[O₂C—C₆H₄—CO₂]. After cooling down to room temperature, the phase absorbs one water molecule to give MIL-53(Al)_{LT} (Al(OH)[O₂C—C₆H₄—CO₂].H₂O).

### 7.3. X-Ray Diffraction Pattern of the As-Made Material

FIG. 32 shows: X-Ray diffraction pattern of MIL-53(Al) as-synthesised (λ_{Cu}=1.5406 Å)

### 7.4. TGA Analysis

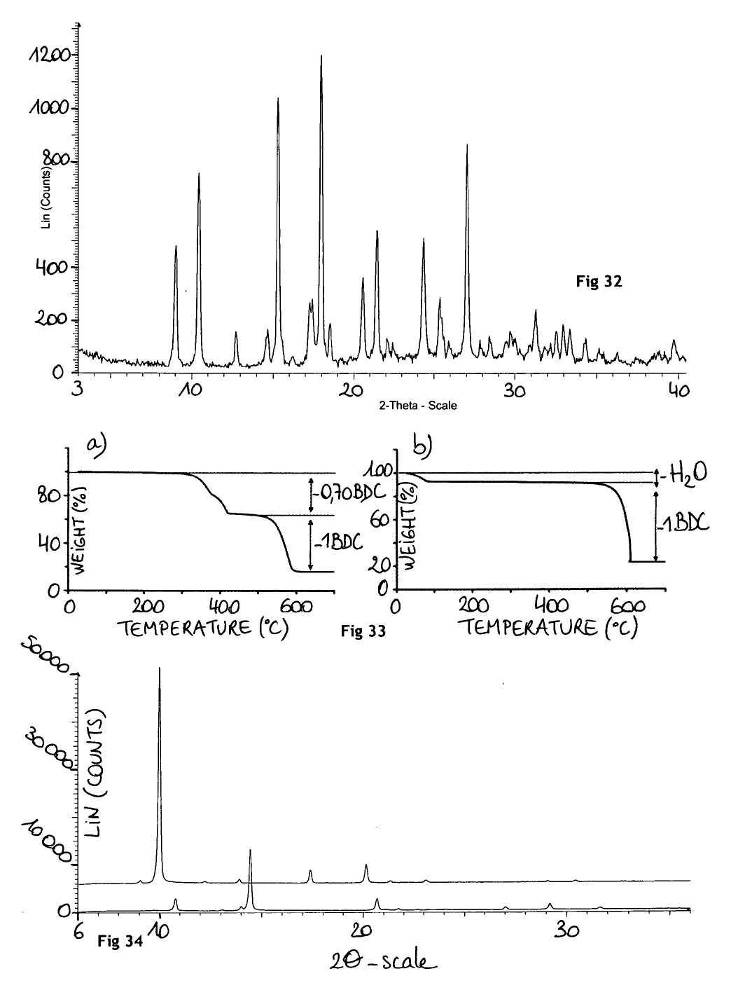

FIG. 33 shows: TGA of (a): MIL-53(Al)as and (b): MIL-53(Al)_{LT} under air atmosphere (heating ramp: 5° C./minute)

### 7.5. Activation Protocol for This Material

An activation route was developped for removing the unreacted terephthalate species encapsulated within the channels of the 3D framework. MIL-53(Al)as was treated by solvothermal treatment in dimethylformamide (DMF) at 423 K overnight. Typically, one gram of MIL-53as was dispersed in 25 ml of DMF and put in a Teflon liner steel autoclave overnight. After cooling, the product was filtrated and calcined ovenight at 280° C. (Al) under air for 36 hours. The solid adsorbs water back at room temperature to give MIL-53(Al)_{LT}.

### 7.6. X-Ray Diffraction Pattern of the Calcined Material

FIG. 34 shows: X-Ray diffraction patterns of MIL-53(Al)_{LT} (below) and MIL-53(Al)_{HT} (above) (λ_{Co}−1.79 Å)

### 7.7. Nitrogen Isotherm at 77 K for the Calcined Material

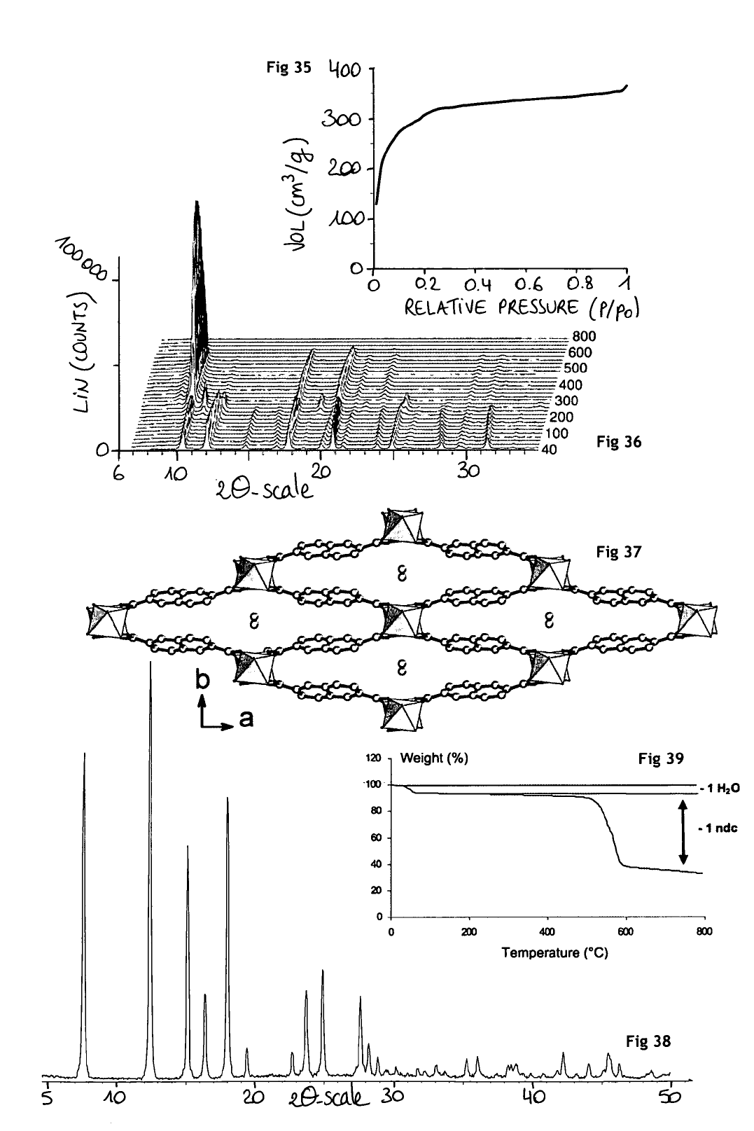

FIG. 35 shows: N₂ adsorption-desorption isotherm of MIL-53(Al)_{HT} at 77 K (P₀=1 atm.) (outgassing conditions: 200° C. overnight under vacuum)

### 7.8. MIL-53(Al): A Breathing Solid

FIG. 36 shows: X-ray thermodiffractogram of MIL-53(Al)as under air (40-800° C.). For clarity, a 2θ offset is applied for each pattern collected every 20° C., except the two last ones collected every 100° C. A breathing phenomenon identical to that to MIL-53(Cr) was observed upon water dehydration.

### 8. MIL-69(Al)

### 8.1. Crystal Structure

MIL-69 exhibits a three-dimensional structure built-up from aluminum(III) octahedra and 2,6 Naphthalenedicarboxylate ions creating a three-dimensional framework with a 1-d pore channel system of ca. 3.5 A free aperture (see FIG. 37). Pores of MIL-69 or Al^{III}(OH)[O₂C—C₁₀H₆—CO₂].H₂O are filled with free water molecules located at the centre of the pores, strongly interacting through hydrogen bonds with oxygen atoms or hydroxyl groups of the inorganic network. Crystal data for MIL-69(Al): monoclinic space group C2/c with a=24.598(2) Å, b=7.5305(6) Å, c=6.5472(5) Å, beta=106.863(8)° and Z=4.

### 8.2. Standard Synthesis Procedure

The synthesis of MIL-69(Al) was carried out as described in the publication [Loiseau et al, C. R. Chimie, 8 765 (2005)], under hydrothermal conditions using aluminum nitrate nonaahydrate (Al(NO₃)₃.9H₂O, 98+%, Carlo Erba Regenti), 2,6-naphthaleneDiCarboxylic acid C₁₀H₆-2,6-(CO₂H)₂>98%, Avocado, noted NDC hereafter), potassium hydroxide (KOH, Aldrich, 90%) and de-ionized water. The reaction was performed in a 23 ml Teflon-lined stainless steel Parr bomb under autogenous pressure for 16 hours days at 210° C. The molar composition of the starting gels was: 1 Al(NO₃)₃.9H₂O (1.314 g): 0.5 NDC (0.3783 g): 1.2 KOH (0.244 g): 80 H₂O (5 ml). After filtering off and washing with de-ionized water, the resulting white product was first identified by powder X-ray diffraction. It consists of the as-synthesized MIL-69(Al) (Al(OH)[O₂C—C₁₀H₆—CO₂].H₂O).

### 8.3. X-Ray Diffraction Pattern of the As-Made Material

FIG. 38 shows: X-Ray diffraction pattern of MIL-69(Al) as-synthesised (λ_{Cu}=1.5406 Å)

### 8.4. TGA Analysis

FIG. 39 shows: TGA of MIL-69(Al)as (heating ramp: 3° C./minute)

### 8.5. Activation Protocol for This Material

No activation procedure. Water is removed by heating at 100° C. under air or under vaccum.

No significant BET surface area is present for MIL-69(Al)

MIL-69(AL) network does not breathe significantly upon the hydration-dehydration process.

### 9. MIL-96(Al)

### 9.1. Crystal Structure

MIL-96 exhibits a three-dimensional structure built-up from aluminum(III) octahedra and 1,3,5-benzenetricarboxylate ions creating a three-dimensional framework from the close packing of small cavities (400-600 Å³) of 2.5-3.5 Å free aperture (see FIG. 40). Its 3D frameworks consists of corrugated hexagonal ring of chains of eighteen Al-centered octahedra connected to each other to μ₃-oxo centered trinuclear units of octahedrally coordinated Al cations through the trimesate linker. Pores of MIL-96 or Al₁₂O(OH)₁₈(H₂O)₃(Al₂(OH)₄)[C₆H₃(CO₂)₃].24H₂O are filled with free water molecules located at the centre of the pores, strongly interacting through hydrogen bonds with oxygen atoms or hydroxyl groups of the inorganic network. Crystal data for MIL-96(Al): hexagonal space group P63/mmc with a=b=14.2074(2) Å, c=31.2302(9)(1) Å and Z=18.

FIG. 40 shows: Projection of the structure of MIL-96 (Al) along the c axis showing the hexagonal network of the aluminium octahedra containing the 18-membered rings connected the μ₃-oxo centered trinuclear units, via the trimesate ligands.

### 9.2. Standard Synthesis Procedure

The synthesis of MIL-96 (Al) was previously described in J. Am. Chem. Soc. 128 10223 (2006). It was carried out under hydrothermal conditions using aluminium nitrate nonaahydrate (Al(NO₃)₃.9H₂O, 98%, Carlo Erba Regenti), 1,3,5-BenzeneTriCarboxylic acid (C₆H₃-1,3,5-(CO₂H)₃>98%, Aldrich, noted BTC hereafter) and de-ionized water. The reaction was performed in a 23 ml Teflon-lined stainless steel Parr bomb under autogenous pressure for 5 hours days at 200° C. The molar composition of the starting gels was: 1 Al(NO₃)₃.9H₂O (1.314 g): 1.0 BTC (0.105 g): 80 H₂O (5 ml). After filtering off and washing with de-ionized water, the resulting white product was first identified by powder X-ray diffraction. It consists of the as-synthesized MIL-96(Al) (Al₁₂O(OH)₁₈(H₂O)₃(Al₂(OH)₄)[C₆H₃(CO₂)₃].b 24H₂O).

### 9.3. X-Ray Diffraction Pattern of the As-Made Material

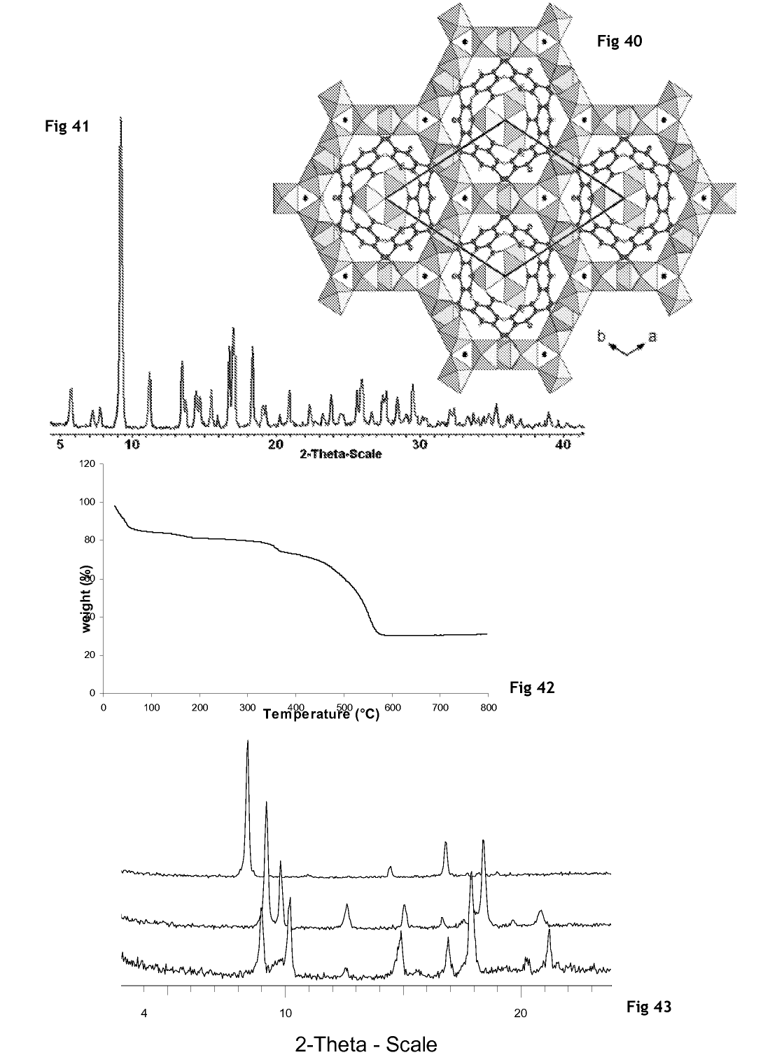

FIG. 41 shows: X-Ray diffraction pattern of MIL-96(Al) as-synthesised (λ_{Cu}=1.5406 Å)

### 9.4. TGA Analysis

FIG. 42 shows: TGA of MIL-96(Al) (heating ramp: 2° C./minute, under O₂)

### 9.5. Activation Protocol for This Material

No activation procedure. Water is removed by heating at 100° C. under air or under vacuum.

No significant BET surface area is observed for MIL-96(Al) although CH₄ and CO₂ adsorption is observed at room temperature and H₂ at 77K (see paper related to MIL-96, Loiseau et al. J. Am. Chem. Soc. 128 10223 (2006)).

### 10. MIL-47(V)

The synthesis, activation and characterization are derived from K. Barthelet et al., Angew. Chem., Int. Ed. 2002, 41, 281.

### 10.1 Synthesis

9.5 g of vanadium(III) chloride (Aldrich, 99%) and 9.75 g of 1,4-benzene dicarboxylic acid H₂BDC (Aldrich 99%)) are placed in a 500 mL Teflon liner. 150 mL of deionized water were added, and the mixture stirred for five minutes. The mixture is then introduced in a hydrothermal bomb, which is heated at 200° C. for 82 hrs (heating rate: 0.25° C.min⁻¹; cooling rate: 0.25° C.min⁻¹). Crude Mil-47 is recovered by filtration, washed with DMF, acetone and dried in air.

### 10.2 Activation

The crude solid is poured in 150 mL of DMF, and heated at 150° C. in a hydrothermal bomb for 16 hrs. The exchanged solid is recovered by centrifugation, washed with acetone and dried in air. Calcination at 200° C. for 72 hrs afforded 4.5 g (total yield: 33%) activated product.

### 10.3 X-Ray Pattern.

FIG. 43 shows: X-Ray diffraction pattern of MIL-47 (λ_{Cu}=1.5406 Å). From bottom to top: crude, exchanged with DMF, and activated MIL-47.

### 10.4 Crystal Structure.

MIL-47 exhibit a three-dimensional structure built-up from vanadium(III/IV) octahedra and terephthalate ions creating a three-dimensional framework with a 1-d pore channel system of ca. 8.5 Å free aperture. Pores of crude MIL-47 or V^{III}(OH).{O₂C—C₆H₄-0O₂}.{I⁻IO₂C-C₆F1₄-0O₂H}_{0.75} are filled with disordered free terephthalic acid, which can be removed by solvent exchange (to afford V^{III}(OH).{O₂C-C₆H₄—CO₂}.{DMF}x) followed by a calcination to give activated MIL-47 or

### 10.5 Nitrogen Adsorption Isotherm at 77 K.

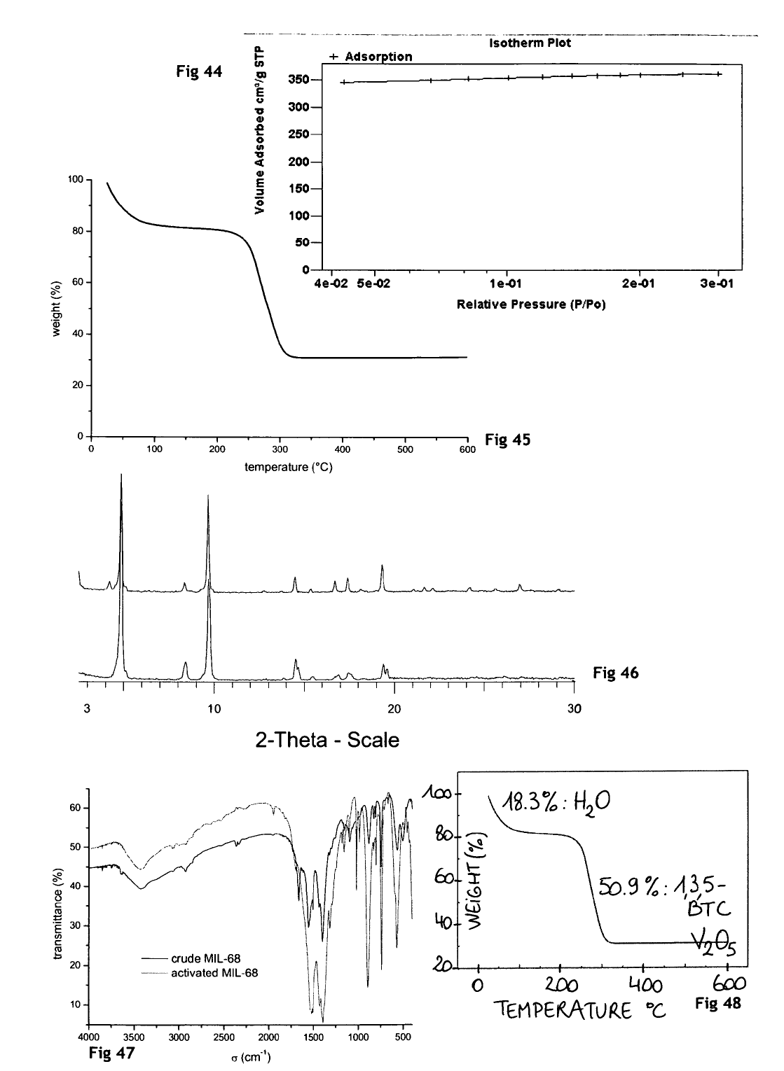

FIG. 44 shows: N₂ adsorption isotherm of activated MIL-47 at 77 K (P₀=1 atm.) (Outgassing conditions: 200° C. overnight under vacuum)

### 11. MIL-68(V)

The synthesis, activation and characterization are derived from K. Barthelet et al., Chem. Commun 2004, 520.

### 11.1 Synthesis.

140 mg of vanadium(IV) oxide sulfate hydrate (Aldrich 97%) and 183 mg of 1,4-benzene dicarboxylic acid H₂BDC (Aldrich 99%)) are placed in a 20 mL Teflon liner. 5 mL of dimethylformamide were added, and the mixture stirred for five minutes. The mixture is then introduced in a hydrothermal bomb, which is heated at 200° C. for 72 hrs (heating rate: 0.25° C.min⁻¹; cooling rate: 0.25° C.min⁻¹). Crude MIL-68 is recovered by filtration, washed with ethanol and dried in air.

### 11.2 Activation.

The crude solid is heated at 250° C. under air for 16 hrs.

### 11.3 Thermogravimetric Analysis.

FIG. 45 shows: Thermogravimetric analysis of the activated MIL-68(V) performed under O₂.

### 11.4 X-Ray Pattern.

FIG. 46 shows: X-Ray diffraction pattern of MIL-68 (λ_{Cu}=1.5406 Å). From bottom to top: crude, and activated MIL-68.

### 11.5 IR Spectroscopy.

FIG. 47 shows: IR spectra of MIL-68. Note the disappearance of the peak at 1664 cm⁻¹, corresponding to the C═O vibration of the DMF molecules, upon activation.

### 11.6 Crystal Structure.

MIL-68 exhibit a three-dimensional structure built-up from vanadium(III/IV) octahedra and terephthalate ions creating a three-dimensional framework with two types of 1-d pore channels, triangular and hexagonal shaped ones. Pores of crude MIL-68 or V^{III}(OH).{O₂C—C₆H₄—CO₂}.{DMF}ₓ are mainly filled with free DMF molecules, which can be removed a calcination to give activated MIL-68 or V^{IV}(O).{O₂C—C₆H₄—CO₂}.

### 12. MIL-100(V)

### 12.1 Synthesis

The vanadium trimesate V₃OH(H₂O)₂O[C₆H₃—(CO₂)₃]₂.x [C₆H₃—(CO₂H)₃]·yH₂O with x≈0.3 and y≈4 was hydrothermally synthesised under autogenous pressure from a mixture of VCl₃ (4 mmol, 628 mg) and triethyl-1,3,5-benzenetricarboxylate (2 mmol, 588 mg) in 5 ml of H₂O (molar ratio 2:1:140). The synthesis was carried out in a Parr autoclave (23 ml volume) at 220° C. for 72 h. The product was retained by filtration as a greenish powder and washed with hot ethanol for removal of unreacted ester or organic ligand. Finally it was washed with deionised water and dried at 100° C. under air.

### 12.2 Activation

Activation was performed at 200° C. under primary vacuum for 24 hours.

### 12.3 Crystal Structure

This solid is sisotructural with Mil-100(Cr) (see structural description above)

### 12.4 TGA

FIG. 48 shows: Thermogravimetric analysis of the activated MIL-100(V) performed under O₂.

### 12.5 X-Ray Pattern

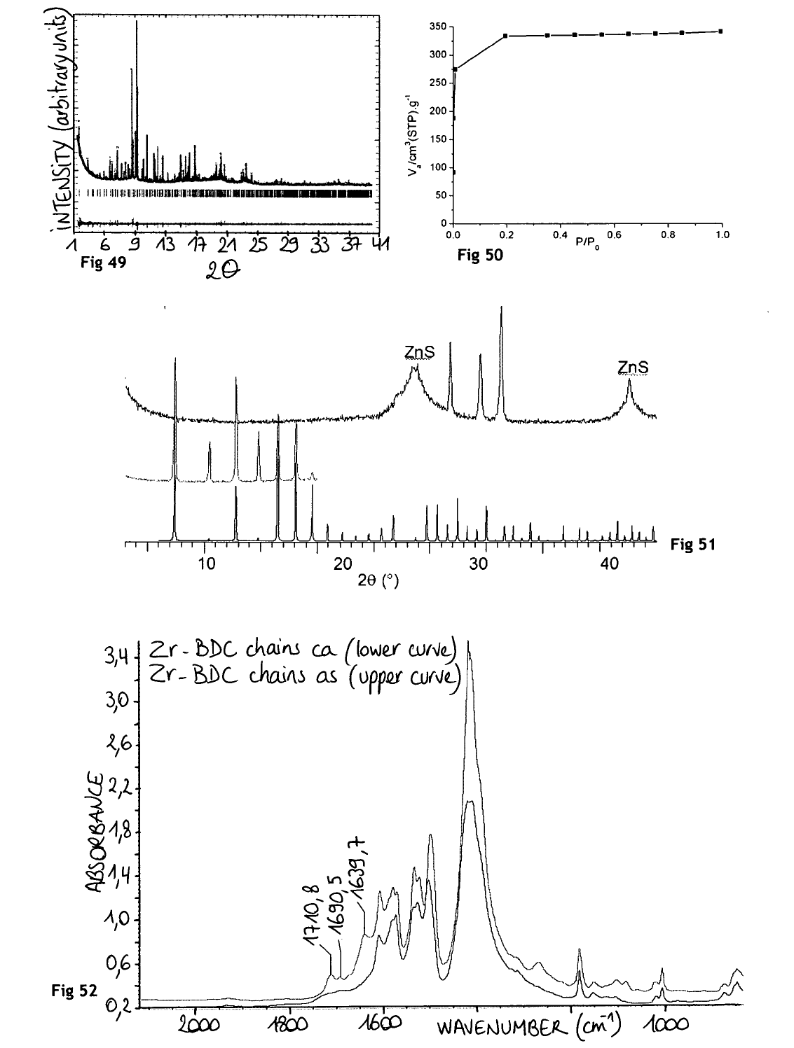

FIG. 49 shows: X-Ray diffraction pattern of MIL-100(V) (λ_{Cu}=1.29175(2)Å).

### 13. ZIF-8

This compound was synthesized and activated following the experimental details described in: R. Banerjee, A. Phan, B. Wang, C. Knobler, H. Furukawa, M. O'Keeffe, O. M. Yaghi, Science 2008, 319, 939.

### 13.1 Nitrogen Adsorption Isotherm at 77 K

FIG. 50 shows: N₂ adsorption isotherm of activated ZIF-8 at 77 K (P₀=1 atm.)

### 13.2 X-Ray Powder Pattern

FIG. 51 shows: X-Ray diffraction pattern of ZIF-8 (λ_{Cu}=1.5406 Å). From top to bottom: theoretical diagram, crude product, after H2S treatment.

### 14. ZrMOF

### 14.1 Synthesis

Terephthalic acid (Aldrich, 5 mmol), zirconium(IV)tetrachloride (Aldrich, 2.5 mmol) and dimethylformamide (Carlo-Erba, 15 mL) were placed in a 125 mL teflon lined steel autoclave and heated at 220° C. for 16 hours. The resulting white solid was recovered by flirtation, washed with dimethylformamide, acetone, and dried in air. The activated solid was obtained upon heating at 300° C. under primary vacuum for 16 hrs.

### 14.2 Infra-Red Spectroscopy

FIG. 52 shows: As-synthesized (top) and activated (bottom) ZrMOF.

The traces of free terephthalic acid remaining in the as-synthesized solid (1690 cm⁻¹) were eliminated upon calcination (see bottom graph).

### 14.3 TGA

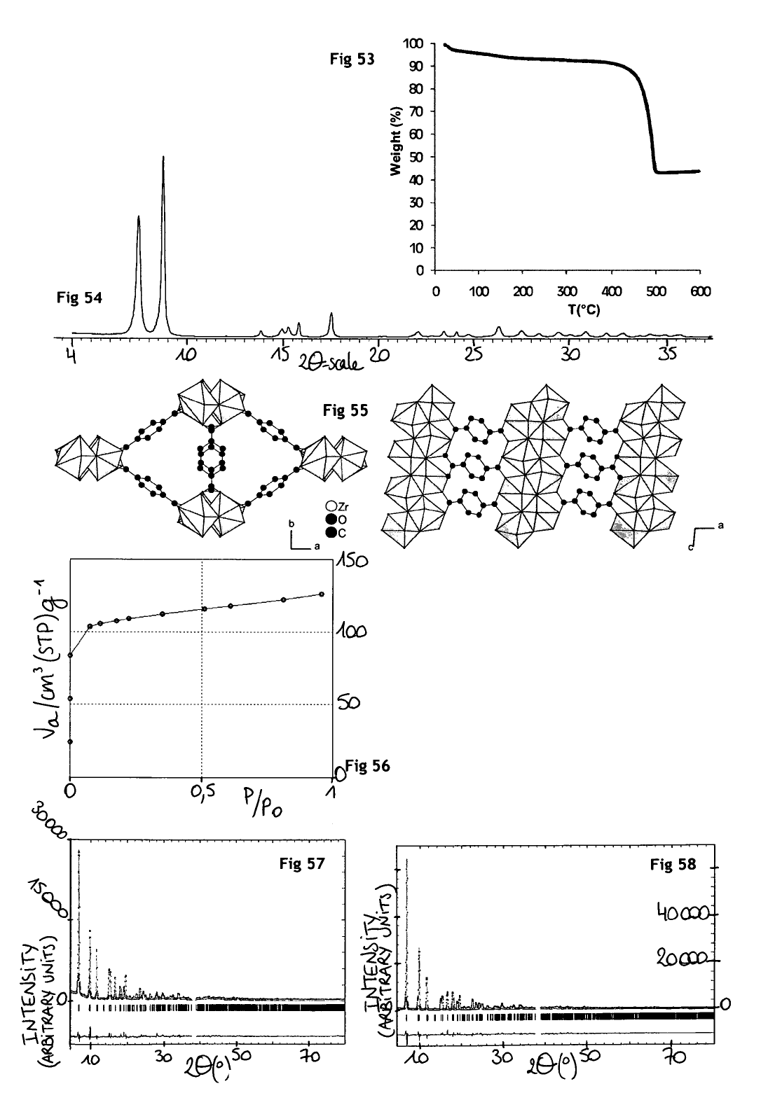

FIG. 53 shows: TG analysis of the as-synthesized MIL-Zr1 solid performed under O₂.

The mass loss (10%) observed at low-temperature (<200° C.) is associated with the departure of free terepthalic acid. The solid in stable up to 450° C.

### 14.4 X-Ray Powder Pattern and Structure

FIG. 54 shows: Powder XRD pattern of the activated MI L-Zr1 (λ=1.5406 Å).

The structure was solved ab-initio form XR powder data.

Unit cell: monoclinic, S.G. I2/a, a=23.822(1) Å, b=11.190(1) Å, c=7.807(1) Å, B=94.73(2)°, V=2073.9(3) Å³.
Atomic coordinates:

| Atom | Wyck. | x | y | z |
|---|---|---|---|---|
| Zr | 8f | 0.80550 | 0.23300 | 0.13900 |
| O4 | 8f | 0.78020 | 0.27070 | 0.38590 |
| O5 | 8f | 0.78630 | 0.04960 | 0.12830 |
| O7 | 8f | 0.88600 | 0.32040 | 0.13230 |
| O1 | 8f | 0.79320 | 0.43640 | 0.07110 |
| C5 | 4e | 3/4 | 0.49880 | 0 |
| O2 | 8f | 0.86480 | 0.16350 | 0.34970 |
| C1 | 8f | 0.90100 | 0.15050 | 0.48900 |
| C2 | 8f | 0.94810 | 0.07760 | 0.47130 |
| C3 | 8f | 0.96410 | 0.01050 | 0.33950 |
| C4 | 8f | 0.01130 | −0.06790 | 0.37040 |
| C6 | 4e | 3/4 | 1.03340 | 0 |
| C7 | 4e | 3/4 | 0.90400 | 0 |
| C9 | 8f | 0.70350 | 0.83910 | −0.07800 |
| C10 | 8f | 0.70660 | 0.70930 | −0.09150 |
| C8 | 4e | 3/4 | 0.64680 | 0 |

FIG. 55 shows: View of the structure along (left) and perpendicular to (right) the double chain axis.

The solid is built up from inorganic double chains of edge-sharing ZrO₇ polyhedra, connected through the terephthalate linker. This defines one dimensional pores running along the chains axis.

### 14.5 Nitrogen Sorption

FIG. 56 shows: Nitrogen sorption isotherm (T=77 K)

The nitrogen sorption isotherm of the activated MIL-Zr1 solid was measured after further activation at 200° C. under vacuum for 16 hours. The resulting maximal capacity (P/P₀=0.95) and BET surface area are 125 cm³.g⁻¹ (STP) and 390(10) m².g⁻¹ respectively.

### 15. MIL-125 and MIL-125(NH₂)

### 15.1 Synthesis

Synthesis of MIL-125 or Ti₈O₈(OH)₄[O₂C—C₆H₄—CO₂]₆ was obtained starting from 1.5 mmol of terephthalic acid or 1,4 Benzenedicarboxylic acid (250 mg) (Aldrich, 98%), 1 mmol of titanium isoproproxide Ti(OiPr)4 (0.3 ml) (Acros Organics, 98%), introduced in a solution of 4.5 ml of dimethylformamide (Acros Organics, extra-dry) and 0.5 ml of dry methanol (Aldrich, 99.9%). The mixture was stirred gently during 5 minutes at room temperature and then further introduced in a 23 ml Teflon liner and then put into a metallic PAAR digestion bomb at 150° C. during 15 hours. Back to room temperature, the white solid was recovered by r filtration, washed twice with aceton and dried under air at room temperature. The free solvant was removed by calcination at 200° C. overnight during 12 hours.

Synthesis of MIL-125(NH2) or Ti₈O₈(OH)₄[O₂C—C₆H₃(NH₂)—CO₂]₆: 1.5 mmol of 2-aminoterephthalic acid (270 mg) (Aldrich, 98%) and 0.67 mmol of titanium isoproproxide Ti(OiPr)4 (0.2 ml) (Acros Organics, 98%), introduced in a solution of 2.5 ml of dimethylformamide (Acros Organics, extra-dry) and 2.5 ml of dry methanol (Aldrich, 99.9%). The mixture was stirred gently during 5 minutes at room temperature and then further introduced in a 23 ml Teflon liner and then put into a metallic PAAR digestion bomb at 100° C. during 15 hours. Back to room temperature, the white solid was recovered by r filtration, washed twice with aceton and dried under air at room temperature. The free solvant was removed by calcination at 200° C. overnight during 12 hours.

### 15.2 Structure Determination

The crystal structure of MIL-125 has been determined using high resolution X-Ray powder diffraction data (Bruker D5000 (θ-2θ mode) diffractometer (λ(Cu Kα1, Kαa2)=1.54059, 1.54439 Å)). The cell parameters have been obtained using the Dicvol software (A. Boultif, D. Louër, J. Appl. Crystallogr. 1991, 24, 987) with an othorhombic sapce group I 4/mmm (n° 139) with a=18.654(1)Å, c=18.144(1)Å, Cell volume of 6313.9(6)Å3.

The pattern matching has been realised using Fullprof17 and its graphical interface Winplotr.18 Atomic coordinates of most framework atoms (Ti atoms, most of O atoms) have been obtained by direct method using the Expo software.16 The remaining framework atoms (O and C) as well as the free water molecules by successive Fourier differences using Shelxl.

Finally, the atomic positions have been refined using dans Fullprof and Winplotr. Soft distances and angles constraints have been used (distances : Ti—O, C—C et C—O; angles: O—Ti—O and O—C—O, C—C—C) during the refinement. The final reliability factors are satisfactory (see tableau S1). The Rietveld plot is the following (FIG. S6). The final atomic positions and angles are reported in Table S2 and S3.

FIG. 57 shows: Rietveld plot of MIL-125. black: experimental points; grey: calculated points; in black (vertical lines): Bragg peaks; black (below): difference pattern (exp.-calc.).

The crystal structure of MIL-125(NH2) has been determined using high resolution X-Ray powder diffraction data (Bruker D5000 (θ-2θ mode) diffractometer (λ(Cu Kα1, Kα2)=1.54059, 1.54439 Å)). The cell parameters have been obtained using the Dicvol software (A. Boultif, D. Louër, J. Appl. Crystallogr. 1991, 24, 987) with an othorhombic space group I 4/mmm (n° 139) with a=18.654(1)Å, c=18.144(1)Å, Cell volume of 6313.9(6)Å³.

The pattern matching has been realised using Fullprof17 and its graphical interface Winplotr.18 Atomic coordinates of most framework atoms (Ti atoms, most of O atoms) have been obtained by direct method using the Expo software.16 The remaining framework atoms (O and C) as well as the free water molecules by successive Fourier differences using Shelxl.

Finally, the atomic positions have been refined using dans Fullprof and Winplotr. Soft distances and angles constraints have been used (distances: Ti—O, C—C et C—O; angles: O—Ti—O and O—C—O, C—C—C) during the refinement. The final reliability factors are satisfactory (see tableau S1). The Rietveld plot is the following (FIG. S6). The final atomic positions and angles are reported in Table S2 and S3.

FIG. 58 shows: Rietveld plot of MIL-125(NH2). experimental points; calculated points; Bragg peaks; difference pattern (exp.-calc.).

The following table shows crystallographic data and refinement parameters of MIL-125 and MIL-125(NH₂) or Ti^{IV}₄O₄(OH)₂.{O₂C—C₆H₄—CO₂}₃ and Ti^{IV}₄O₄(OH)₂.{O₂C—₆H₃(NH₂—CO₂}₃

| Formula | MIL-125 | MIL-125(NH₂) |
|---|---|---|
| Composition (dried form) | Ti₁₆O₇₂C₉₆H₆₄ | Ti₁₆O₇₂N₄C₉₆H₇₆ |
| Molar mass (g · mol−1) | 3135 | 3315 |
| Calculated Density | 0.81 | 0.86 |
| (g · cm−3) (dried form) | | |
| Symmetry | Orthorhombic | Orthorhombic |
| Space group | I4/m m m | I4/m m m |
| | (n^{o} 139) | (n^{o} 139) |
| a (Å) | 18.654 (1) | 18.673 (1) |
| c (Å) | 18.144 (1) | 18.138 (1) |
| V (Å3) | 6313.9 (1) | 6324.5 (1) |
| Z | 4 | 4 |
| Wavelength λ (Cu Kα) | 1.54059, 1.54439 | 1.54059, 1.54439 |
| χ = Kα2/Kα1 | 0.5 | 0.5 |
| Temperature (K) | 296 | 296 |
| Angular range 2θ (°) | 5-80 | 5-80 |
| Number of reflections | 662 | 644 |
| (Bragg peaks) | | |
| Number of independant atoms | 20 | 23 |
| Number of intensity parameters | 37 | 43 |
| Number of profile parameters | 10 | 10 |
| Number of distances and angle | 35 | 35 |
| constraints | | |
| RP | 8 | 11.9 |
| RWP | 10.9 | 15.5 |
| RBragg | 10.4 | 13.6 |
| Overall thermal parameter | 3.9 (1) | 2.9 (1) |
| Profile Function | Pseudo-Voigt | Pseudo-Voigt |
| Background | Experimental | Experimental |
| | (32 points) | (35 points) |
| Number of asymetry parameters | 2 | 2 |

### 15.3 Structure Description

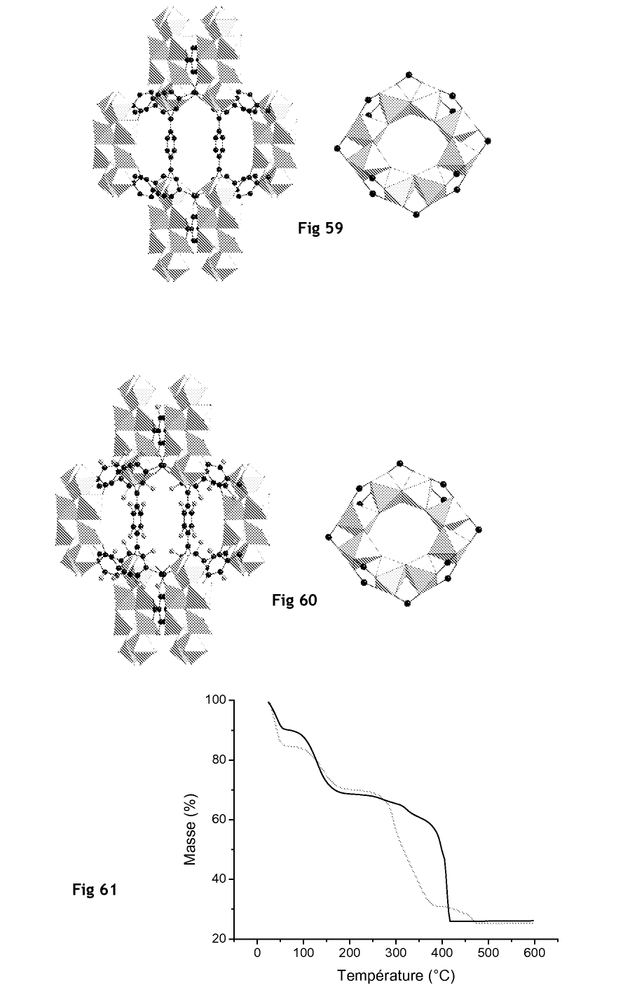

MIL-125 is built up from edge- and corner-sharing TiO₅(OH) octahedra that form octameric wheels SBU (SBU for Secondary Building Units) (see FIG. 59). The SBUs are related to twelve other SBUs through terephthalate dianions to produce a three dimensional network of inorganic wheels, with four connections within the plane of the octameric wheel and four above and four below it. The structure could also be described as a pseudo-cubic array of two types of porosity, a first hybrid porous superoctahedron, reminiscent of the inorganic cubic structure, and hybrid supertetrahedron with in both cases one inorganic octameric wheel at each summit of the octahedron and terephthalate linkers at the vertices. The triangular windows exhibit a free aperture of ca. 5 to 7 Å while the giant octahedral possess a free pore size close to 6.5 and 12.7 Å. Oxo and hydroxo groups are present at the core of the SBU.

FIG. 59 shows: (left) view of the structure of MIL-125 along the a (or b) axis; right: view of the octameric wheel of titanium octahedron (titanium, carbon atoms, are in grey and black, respectively).

Atomic coordinates of MIL-125 in its hydrated form:

| Atom | Wickoff | Site Occupancy | x/a | y/b | z/c |
|---|---|---|---|---|---|
| Ti | 16l | | 0.20830 | 0.07400 | 1/2 |
| O1 | 16l | | 0.31110 | 0.05800 | 1/2 |
| O2 | 16n | | 0.18190 | 0 | 0.42650 |
| O3 | 32o | | 0.22590 | 0.14420 | 0.42680 |
| O4 | 8h | | 0.10740 | 0.10740 | 1/2 |
| C1 | 8j | | 0.35070 | 0 | 1/2 |
| C2 | 8j | | 0.42650 | 0 | 1/2 |
| C3 | 16l | | 0.46320 | 0.07050 | 1/2 |
| C4 | 16m | | 0.19400 | 0.19400 | 0.40230 |
| C5 | 16m | | 0.22250 | 0.22250 | 0.32090 |
| C6 | 32o | | 0.20150 | 0.28760 | 0.28980 |
| Ow1 | 8h | | 0.17590 | 0.17590 | 0 |
| Ow2 | 16m | | 0.09180 | 0.09180 | 0.25400 |
| Ow3 | 16n | | 0.40490 | 0 | 0.26520 |
| Ow4 | 4e | | 0 | 0 | 0.56540 |
| Ow5 | 16m | | 0.10650 | 0.10650 | 0.09520 |
| Ow6 | 32o | 50% | 0.24080 | 0.03420 | 0.08380 |
| Ow7 | 16n | 77% | 0.23510 | 0 | 0.22370 |
| Ow8 | 4e | | 0 | 0 | 0.17900 |
| Ow10 | 2a | | 0 | 0 | 0 |

N.B. free water molecules Owi (i=1-10) do not belong to the framework and are present only when the solidis exposed to air moisture.

Principal interatomic distances in Angströms:

| | | | |
|---|---|---|---|
| Ti | O3 | x, y, z | 1.89(1) |
| | O3 | x, y, 1 − z | 1.89(1) |
| | O1 | x, y, z | 1.941(1) |
| | O2 | x, y, z | 1.98(1) |
| | O2 | x, −y, 1 − z | 1.98(1) |
| | O4 | x, y, z | 1.98(1) |
| C1 | O1 | x, −y, 1 − z | 1.31(1) |
| | O1 | x, y, z | 1.31(1) |
| | C2 | x, y, z | 1.41(1) |
| C2 | C1 | x, y, z | 1.41(1) |
| | C3 | x, −y, 1 − z | 1.48(1) |
| | C3 | x, y, z | 1.48(1) |
| C3 | C3 | 1 − x, y, 1 − z | 1.37(1) |
| | C2 | x, y, z | 1.48(1) |
| C4 | O3 | y, x, z | 1.19(1) |
| | O3 | x, y, z | 1.19(1) |
| | C5 | x, y, z | 1.65(1) |
| C5 | C6 | x, y, z | 1.40(1) |
| | C6 | y, x, z | 1.40(1) |
| | C4 | x, y, z | 1.65(1) |
| C6 | C5 | x, y, z | 1.40(1) |
| | C6 | 0.5 − y, 0.5 − x, 0.5 − z | 1.47(1) |

MIL-125(NH2) is built up from edge- and corner-sharing TiO5(OH) octahedra that form octameric wheels SBU (SBU for Secondary Building Units) (see FIG. 60). The SBUs are related to twelve other SBUs through terephthalate dianions to produce a three dimensional network of inorganic wheels, with four connections within the plane of the octameric wheel and four above and four below it. The structure could also be described as a pseudo-cubic array of two types of porosity, a first hybrid porous superoctahedron, reminiscent of the inorganic cubic structure, and hybrid supertetrahedron with in both cases one inorganic octameric wheel at each summit of the octahedron and terephthalate linkers at the vertices. The triangular windows exhibit a free aperture of ca. 5 to 7 Å while the giant octahedral possess a free pore size close to 6.5 and 12.7 Å. Oxo and hydroxo groups are present at the core of the SBU. Please note also that the amino groups are disordered on four cristallographic positions and a 25% occupation site has been given to the nitrogen atom of the amino groups.

FIG. 60 shows: left: view of the structure of MIL-125(NH2) along the a (or b) axis; right: view of the octameric wheel of titanium octahedron (titanium, carbon atoms, are in grey and black, respectively).

Atomic coordinates of MIL-125(NH2) in its hydrated form:

| Atom | Wickoff | Site Occupancy | x/a | y/b | z/c |
|---|---|---|---|---|---|
| Ti | 16l | | 0.20487 | 0.07254 | 1/2 |
| O1 | 16l | | 0.31087 | 0.05903 | 1/2 |
| O2 | 16n | | 0.19180 | 0 | 0.42820 |
| O3 | 32o | | 0.22350 | 0.13977 | 0.42966 |
| O4 | 8h | | 0.10766 | 0.10766 | 1/2 |
| C1 | 8j | | 0.34876 | 0 | 1/2 |
| C2 | 8j | | 0.42505 | 0 | 1/2 |
| C3 | 16l | | 0.46289 | 0.07112 | 1/2 |
| N1 | 16l | 25% | 0.40989 | 0.13166 | 1/2 |
| C4 | 16m | | 0.19137 | 0.19137 | 0.40513 |
| C5 | 16m | | 0.22438 | 0.22438 | 0.32907 |
| C6 | 32o | | 0.18500 | 0.28300 | 0.28828 |
| N2 | 32o | 25% | 0.32500 | 0.12500 | 0.33000 |
| Ow1 | 8h | | 0.17979 | 0.17979 | 0 |
| Ow2 | 16m | 81% | 0.07677 | 0.07677 | 0.29254 |
| Ow3 | 16n | 83% | 0.38985 | 0 | 0.28589 |
| Ow4 | 2b | | 0 | 0 | 1/2 |
| Ow5 | 16m | 79% | 0.09328 | 0.09328 | 0.08084 |
| Ow6 | 32o | 84% | 0.24910 | 0.06480 | 0.10202 |
| Ow7 | 16n | 84% | 0.24188 | 0 | 0.24106 |
| Ow8 | 4e | | 0 | 0 | 0.17823 |
| Ow9 | 4e | | 0 | 0 | 0.64063 |
| Ow10 | 2a | | 0 | 0 | 0 |

N.B. free water molecules Owi (i=1-10) do not belong to the framework and are present only when the soli dis exposed to air moisture.

Principal interatomic distances in Angströms:

| | | | |
|---|---|---|---|
| Ti | O3 | x, y, z | 1.82(1) |
| | O3 | x, y, 1 − z | 1.82(1) |
| | O2 | x, −y, 1 − z | 1.90(1) |
| | O2 | x, y, z | 1.90(1) |
| | O4 | x, y, z | 1.93(1) |
| | O1 | x, y, z | 2.00(1) |
| C1 | O1 | x, −y, 1 − z | 1.31(1) |
| | O1 | x, y, z | 1.31(1) |
| | C2 | x, y, z | 1.43(1) |
| C2 | C1 | x, y, z | 1.43(1) |
| | C3 | x, −y, 1 − z | 1.50(1) |
| | C3 | x, y, z | 1.50(1) |
| C3 | C3 | 1 − x, y, 1 − z | 1.39(1) |
| | N1 | x, y, z | 1.50(1) |
| | C2 | x, y, z | 1.50(1) |
| N1 | C3 | x, y, z | 1.50(1) |
| C4 | O3 | y, x, z | 1.22(1) |
| | O3 | x, y, z | 1.22(1) |
| | C5 | x, y, z | 1.63(1) |
| C5 | C6 | x, y, z | 1.51(1) |
| | C6 | y, x, z | 1.51(1) |
| | C4 | x, y, z | 1.63(1) |
| C6 | C5 | x, y, z | 1.51(1) |
| | N2 | y, x, z | 1.56(1) |
| | C6 | 0.5 − y, 0.5 − x, 0.5 − z | 1.63(1) |
| N2 | C6 | y, x, z | 1.56(1) |

### 15.4 Thermal Gravimetric Analysis

MIL-125 exhibits two caracteristic weight losses: departure of free solvent trapped in the pores (methanol from 25° C. to 100° C. then DMF from 100 to 200° C. Then, degradation of the framework occurs around 400° C. with a departure of the carboxylic acid from the framework. Residual solid is anatase TiO₂.

The same behavior is observed for MIL-125(NH2) but with a lower thermal stability (<300° C.). Residual solid is anatase TiO₂.

FIG. 61 shows: Thermal gravimetric analysis of MIL-125 (TiBDC) (black) and MIL-125(NH2) (grey) (TiNH2BDC) under air atmosphere (heating rate: 3° C./minute) (5 mg of product, TA2050 analyser).

### 15.5 Infra-Red Spectroscopy

Infra-red spectra of MIL-125 and MIL-125(NH2) show caracteristic bands of metal carboxylate (bands around 1380 and 1600 cm⁻¹), a large band around 3400 cm⁻¹ corresponding to the free solvent trapped inside the pores as well as the structure bands of the inorganic sub-netwrok (O—Ti—O) at short wavenumber (400-800 cm⁻¹).

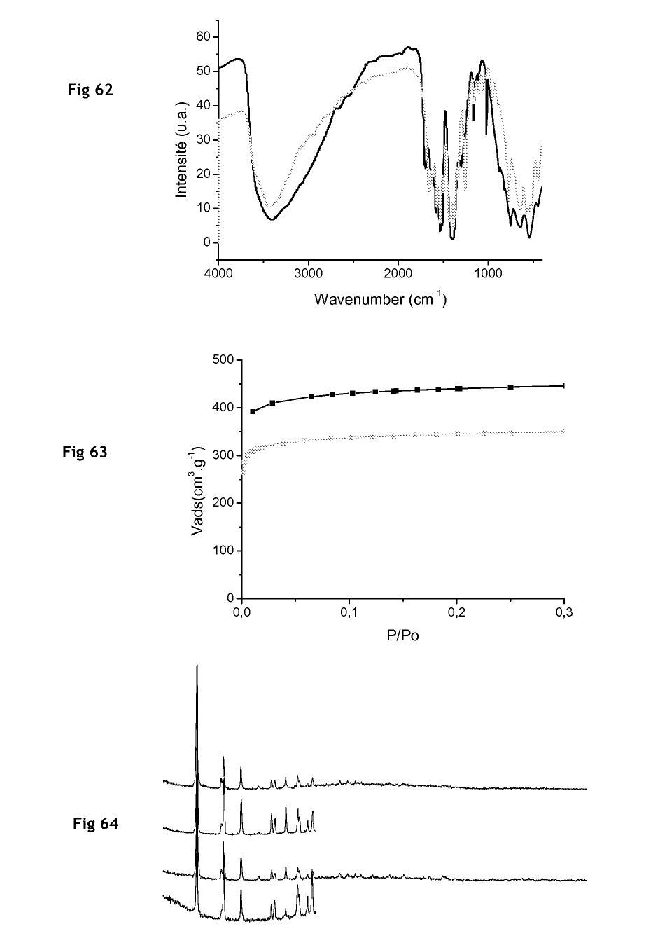

FIG. 62 shows: Infra-red spectra of MIL-125 (black) and MIL-125(NH2) (grey) (KBr pellet with sample as trace; Nicolet Instrument).

### 15.6 Nitrogen Sorption Experiments.

The porosity of MIL-125 and MIL-125(NH2) were estimated by a gas sorption experiment in liquid nitrogen using the Micromeritics ASAP2010 apparatus (surface area calculations: p/p0 between 0.01 and 0.2 (BET) and 0.06-0.2 (Langmuir)). p is the gas vapour pressure at a given temperature T; p0 is the saturation vapour pressure at a given temperature T. The nitrogen sorption experiment on the activated samples (50 mg of solid degassed at 200° C. overnight at P=10-3Torr) revealed a type I isotherm without hysteresis on desorption, characteristic of a microporous solid.

FIG. 63 shows: nitrogen sorption isotherms at T=−196° C. of MIL-125 (black) and MIL-125(NH2) (grey) (P0=1 atm.)

The specific surface areas (BET and Langmuir methods) are high (see table):

| | | Langmuir | Microporous volume |
|---|---|---|---|
| Solid | BET (m² · g⁻¹) | (m² · g⁻¹) | (cm³ · g⁻¹)* |
| MIL-125 | 845 (20) | 1067 (10) | 0.25 |
| MIL-125(NH₂) | 1200 (20) | 1550 (10) | 0.48 |

*calculated from t-plot method

### 15.7 Elemental Analysis

| Solid (activated) | C/Ti (theoretical 6.0) |
|---|---|
| MIL-125 | 5.8 |
| MIL-125(NH₂) | 6.3 |

### 15.8 XR Powder Pattern

FIG. 64 shows: X-R powder patterns (from the bottom to the top) of activated MIL-125, MIL-125 after H₂S sorption, MIL-125-NH2, MIL-125-NH2 after H₂S sorption.

The frameworks of MIL-125 and MIL-125-NH2 remain intact upon H₂S sorption, no trace of TiS₂ is detected.

1. Method for separating a sulphur compound from a gas mixture comprising contacting said gas mixture with an adsorbent, wherein the adsorbent comprises a metal-organic framework (MOF) comprising a tridimensional succession of motifs having the formula:
MₘOₖXₗLₚ
wherein
M is selected from the group of metal ions consisting of Ti⁴⁺, Zr⁴⁺, Mn⁴⁺, Si⁴⁺, Al³⁺, Cr³⁺, V³⁺, Ga³⁺, Mn³⁺, Mn²⁺, Mg²⁺ and combinations thereof;
m is 1, 2, 3 or 4. preferably 1 or 3;
k is 0, 1, 2, 3 or 4, preferably 0 or 1;
l is 0, 1, 2, 3 or 4, ₚreferably 0 or 1;
p is 1, 2, 3 or 4, preferably 1 or 3;
X is selected from the group consisting of OH⁻, Cl⁻, F⁻, I⁻, Br⁻, SO₄²⁻, NO₃⁻, ClO₄₊, PF₆⁻, BF₃⁻, —(COO)ₙ⁻, R¹—(S0₃)ₙ⁻; R¹—(PO₃)ₙ⁻, wherein R¹ is selected from the group consisting of hydrogen and C₁₋₁₂alkyl, and wherein n is 1, 2, 3 or 4;
L is a spacer ligand comprising a radical R comprising q carboxylate groups *—COO-#, wherein
q is 1, 2, 3, 4, 5 or 6, preferably 2, 3 or 4;
*shows the carboxylate attachment point to the radical R;
# shows the carboxylate attachment point to the metal ion M;
R is selected from the group consisting of C₁₋₁₂alkyl, C₂₋₁₂alkene, C₂₋₁₂alkyne, mono- and poly-cyclic C₁₋₅₀aryl, mono- and poly-cyclic C₁₋₅₀heteroaryl and organic radicals comprising a metal material selected from the group consisting of ferrocene, porphyrin, phthalocyanine and Schiff base R^{X1}R^{X2}—C═N—R^{X3}, wherein R^{X1} and R^{X2} are independently selected from the group consisting of hydrogen, C₁₋₁₂alkyl, C₂₋₁₂alkene, C₂₋₁₂alkyne and mono- and poly-cyclic C₆₋₅₀aryl and wherein R^{X3} is selected from the group consisting of C₁₋₁₂alkyl, C₂₋₁₂alkene, C₂₋₁₂alkyne and mono- and poly-cyclic C₆₋₅₀aryl.

2. Method for separating hydrogen sulphide from a gas mixture comprising contacting said gas mixture with an adsorbent, wherein the adsorbent comprises a metal-organic framework (MOF) comprising a tridimensional succession of motifs having the formula:
MₘOₖXₗLₚ
wherein
M is a metal ion V⁴⁺;
m is 1, 2, 3 or 4, preferably 1 or 3;
k is 0, 1, 2, 3 or 4, preferably 0 or 1;
l is 0, 1, 2, 3 or 4, preferably 0 or 1;
p is 1, 2, 3 or 4, preferably 1 or 3;
X is selected from the group consisting of OH⁻, Cl⁻, F⁻, I⁻, Br⁻, SO₄²⁻, NO₃⁻, ClO₄⁻, PF₆⁻, BF₃⁻, —(COO)ₙ⁻, R¹—(S0₃)ₙ⁻, R¹—(PO₃)ₙ⁻, wherein R¹ is selected from the group consisting of hydrogen and C₁₋₁₂alkyl, and wherein n is 1, 2, 3 or 4;
L is a spacer ligand comprising a radical R comprising q carboxylate groups *—COO-#, wherein
q is 1, 2, 3, 4, 5 or 6, preferably 2, 3 or 4;
*shows the carboxylate attachment point to the radical R;
# shows the carboxylate attachment point to the metal ion M;
R is selected from the group consisting of C1-12alkyl, C2-12alkene, C2-12alkyne, mono- and poly-cyclic C1-50aryl, mono- and poly-cyclic C1-50heteroaryl and organic radicals comprising a metal material selected from the group consisting of ferrocene, porphyrin, phthalocyanine and Schiff base RX1RX2-C═N-RX3, wherein RX1 and RX2 are independently selected from the group consisting of hydrogen, C1-12alkyl, C2-12alkene, C2-12alkyne and mono- and poly-cyclic C6-50aryl and wherein RX3 is selected from the group consisting of C1-12alkyl, C2-12alkene, C2-12alkyne and mono- and poly-cyclic C6-50aryl.

3. Method as claimed in claim 1, wherein R is substituted by one or more groups R², independently selected from the group consisting of C₁₋₁₀alkyl, C₂₋₁₀alkene, C₂₋₁₀alkyne, C₃₋₁₀cycloalkyl, C₁₋₁₀heteroalkyl, C₁₋₁₀haloalkyl, C₆₋₁₀aryl, C₃₋₁₀heteroaryl, C₅₋₂₀heterocyclic, C₁₋₁₀alkylC₆₋₁₀aryl , C₁₋₁₀alkylC₃₋₁₀heteroaryl, C₁₋₁₀alkoxy, C₆₋₁₀aryloxy, C₃₋₁₀heteroalkoxy , C₃₋₁₀heteroaryloxy , C₁₋₁₀alkylthio, C₆₋₁₀arylthio, C₁₋₁₀heteroalkylthio, C₃₋₁₀heteroarylthio, F, Cl, Br, I, —NO₂, —CN, —CF₃, —CH₂CF₃, —CHCl₂, —OH, —CH₂OH, —CH₂CH₂OH, —NH₂, —CH₂NH₂, —NHCOH, —COOH, —CONH₂, —SO₃H, —CH₂SO₂CH₃, —PO₃H₂, —B(OR^{G1})₂, and a function -GR^{G1}, wherein G is selected from the group consisting of —O—, —S—, —NR^{G2}—, —C(═O)—, —S(═O)—, —SO₂—, —C(═O)O—, —C(═O)NR^{G2}—, —OC(═O)—, —NR^{G2}C(═O)—, —OC(═O)O—, —OC(═O)NR^{G2}—, —NR^{G2}C(═O)O—, —NR^{G2}C(═O)NR^{G2}—, —C(═S)—, —C(═S)S—, —C(═NR^{G2})—, —C(═NR^{G2})O—, —C(═NR^{G2})NR^{G3}—, —OC(═NR^{G2})—, —NR^{G2}C(═NR^{G3})—, —NR^{G2}SO₂—, —NR^{G2}SO₂NR³—, —NR^{G2}C(═S)—, —SC(═S)NR^{G2}—, —NR^{G2}C(═S)S—, —NR^{G2}C(—S)NR^{G2}—, —SC(═NR^{G2})—, —C(═S)NR^{G2}—, —OC(═S)NR^{G2}—, —NR^{G2}C(═S)O—, —SC(═O)NR^{G2}—, —NR^{G2}C(═O)S—, —C(═O)S—, —SC(═O)—, —SC(═O)S—, —C(═S)O—, —OC(═S)—, —OC(═S)O— and —SO₂NR^{G2}—, wherein each occurrence of R^{G1}, R^{G2} and R^{G3} is selected, independently from the other occurrences of R^{G1}, from the group consisting of an hydrogen atom, an halogen atom, a C₁₋₁₂alkyl function, a C₁₋₁₂heteroalkyl function, a C₂₋₁₀alkene function, a C₂₋₁₀alkyne function , a C₆₋₁₀aryl group, a C₃₋₁₀heteroaryl group, a C₅₋₁₀heterocycle group, a C₁₋₁₀alkylC₆₋₁₀aryl group and a C₁₋₁₀alkylC₃₋₁₀heteroaryl group, or wherein, when G is —NR^{G2}—, R^{G1} and R^{G2} jointly form in common with the nitrogen atom to which they are linked a heterocycle or a heteroaryl.

4. Method as claimed in claim 1, wherein the adsorbent comprises a metal-organic framework (MOF) comprising a motif selected from the group consisting of VO[C₆H₄(CO₂)₂], Al(OH)[C₆H₄(CO₂)₂], Cr(OH)[C₆H₄(CO₂)₂], Al(OH)[C₁₀H₆(CO₂)₂], Al₁O(OH)₁₈(H₂O)₃[C₆H₃—(CO₂)₃]₆.nH₂O, Cr₃OX[C₆H₄(CO₂)₂]₃, Cr₃OX[C₁₂H₈(CO₂)₂]₃, Cr₃OX[C₆H₃(CO₂)₃]₃, Al₈(OH)₁₅(H₂O)₃[C₆H₃(CO₂)₃]₃, V₃OX[C₆H₃(CO₂)₃]₃, ZrO[C₆H₄(CO₂)₂], Ti₈O₈(OH)₄[O₂C—C₆H₄—CO₂]₆ and Ti₈O₈(OH)₄[O₂C—C₆H₃(NH₂)—CO₂]₆.

5. Method as claimed in claim 2, wherein the adsorbent comprises a metal-organic framework (MOF) comprising the motif VO[C₆H₄(CO₂)₂]

6. Method as claimed in claim 1, wherein the sulphur compound to be separated from the gas mixture is hydrogen sulphide.

7. Method as claimed in claim 1, wherein the gas mixture comprises methane.

8. Method as claimed in claim 1, comprising the additional steps of regenerating the adsorbent and using the regenerated adsorbent in said method for separating a sulphur compound.

9. Method of reducing H₂S concentration of a gas mixture having a H₂S content within the range 20 ppm mol to 5% mol to a level below 10 ppm mol, consisting essentially of contacting said gas mixture with an adsorbent comprising a metal-organic framework (MOF).

10. Method as claimed in claim 9, wherein the MOF comprises a tridimensional succession of motifs having the formula:
MₘOₖXₗLₚ
wherein
M is selected from the group of metal ions consisting of Ti⁴⁺, V⁴⁺, Zr⁴⁺, Mn⁴⁺, Si⁴⁺, Al³⁺, Cr³⁺, V³⁺, Ga³⁺, In³⁺, Mn³⁺, Mg²⁺and combinations thereof;
m is 1, 2, 3 or 4, preferably 1 or 3;
k is 0, 1, 2, 3 or 4, preferably 0 or 1;
l is 0, 1, 2, 3 or 4, preferably 0 or 1;
p is 1, 2, 3 or 4, preferably 1 or 3;
X is selected from the group consisting of OH⁻, Cl⁻, F⁻, I⁻, Br⁻, SO₄²⁻, NO₃⁻, ClO₄⁻, PF₆^{-, BF}₃⁻, —(COO)ₙ⁻, R¹—(S0₃)ₙ⁻, R¹—(PO₃)ₙ⁻, wherein R¹ is selected from the group consisting of hydrogen and C₁₋₁₂alkyl, and wherein n is 1, 2, 3 or 4;
L is a spacer ligand comprising a radical R comprising q carboxylate groups *—COO-#, wherein
q is 1, 2, 3, 4, 5 or 6, preferably 2, 3 or 4;
* shows the carboxylate attachment point to the radical R;
# shows the carboxylate attachment point to the metal ion M;
R is selected from the group consisting of C₁₋₁₂alkyl, C₂₋₁₂alkene, C₂₋₁₂alkyne, mono- and poly-cyclic C₁₋₅₀aryl, mono- and poly-cyclic C₁₋₅₀heteroaryl and organic radicals comprising a metal material selected from the group consisting of ferrocene, porphyrin, phthalocyanine and Schiff base R^{X1}R^{X2}—C═N—R^{X3}, wherein R^{X1} and R^{X2} are independently selected from the group consisting of hydrogen, C₁₋₁₂alkyl, C₂₋₁₂alkene, C₂₋₁₂alkyne and mono- and poly-cyclic C₆₋₅₀aryl and wherein R^{X3} is selected from the group consisting of C₁₋₁₂alkyl, C₂₋₁₂alkene, C₂₋₁₂alkyne and mono- and poly-cyclic C₆₋₅₀aryl.

11. Method as claimed in claim 9, wherein the gas mixture comprises methane.

12. Sulphur compound gas adsorber comprising a metal-organic framework (MOF) comprising a tridimensional succession of motifs having the formula:
MₘOₖXₗLₚ
wherein
M is selected from the group of metal ions consisting of Ti⁴⁺, Zr⁴⁺, Mn⁴⁺, Si⁴⁺, Al³⁺, Cr³⁺, V³⁺, Ga³⁺, In³⁺, Mn³⁺, Mn²⁺, Mg²⁺ and combinations thereof;
m is 1, 2, 3 or 4, preferably 1 or 3;
k is 0, 1, 2, 3 or 4, preferably 0 or 1;
l is 0, 1, 2, 3 or 4, preferably 0 or 1;
p is 1, 2, 3 or 4, preferably 1 or 3;
X is selected from the group consisting of OH⁻, Cl⁻, F⁻, I⁻, Br⁻, SO₄²⁻, NO₃⁻, ClO₄⁻, PF₆⁻, BF₃⁻, —(COO)ₙ⁻, R¹—(S0₃)ₙ⁻, R¹—(PO₃)ₙ⁻, wherein R¹ is selected from the group consisting of hydrogen and C₁₋₁₂alkyl, and wherein n is 1, 2, 3 or 4;
L is a spacer ligand comprising a radical R comprising q carboxylate groups *—COO-#, wherein
q is 1, 2, 3, 4, 5 or 6, preferably 2, 3 or 4;
* shows the carboxylate attachment point to the radical R;
# shows the carboxylate attachment point to the metal ion M;
R is selected from the group consisting of C₁₋₁₂alkyl, C₂₋₁₂alkene, C₂₋₁₂alkyne, mono- and poly-cyclic C₁₋₅₀aryl, mono- and poly-cyclic C₁₋₅₀heteroaryl and organic radicals comprising a metal material selected from the group consisting of ferrocene, porphyrin, phthalocyanine and Schiff base R^{X1}R^{X2}—C═N—R^{X3}, wherein R^{X1} and R^{X2} are independently selected from the group consisting of hydrogen, C₁₋₁₂alkyl, C₂₋₁₂alkene, C₂₋₁₂alkyne and mono- and poly-cyclic C₆₋₅₀aryl and wherein R^{X3} is selected from the group consisting of C₄₋₁₂alkyl, C₂₋₁₂alkene, C₂₋₁₂alkyne and mono- and poly-cyclic C₆₋₅₀aryl.

13. Hydrogen sulphide gas adsorber comprising a metal-organic framework (MOF) comprising a tridimensional succession of motifs having the formula:
MₘOₖXₗLₚ
wherein
M is a metal ion V⁴⁺;
m is 1, 2, 3 or 4, preferably 1 or 3;
k is 0, 1, 2, 3 or 4, preferably 0 or 1;
l is 0, 1, 2, 3 or 4, preferably 0 or 1;
p is 1, 2, 3 or 4, preferably 1 or 3;
X is selected from the group consisting of OH⁻, Cl⁻, F⁻, I⁻, Br⁻, SO₄²⁻, NO₃⁻, ClO₄⁻, PF₆⁻, BF₃⁻, —(COO)ₙ⁻, R¹—(S0₃)ₙ⁻, R¹—(PO₃)ₙ⁻, wherein R¹ is selected from the group consisting of hydrogen and C₁₋₁₂alkyl, and wherein n is 1, 2, 3 or 4;
L is a spacer ligand comprising a radical R comprising q carboxylate groups *—COO-#, wherein
q is 1, 2, 3, 4, 5 or 6, preferably 2, 3 or 4;
* shows the carboxylate attachment point to the radical R;
it shows the carboxylate attachment point to the metal ion M;
R is selected from the group consisting of C₁₋₁₂alkyl, C₂₋₁₂alkene, C₂₋₁₂alkyne, mono- and poly-cyclic C₁₋₅₀aryl, mono- and poly-cyclic C₁₋₅₀heteroaryl and organic radicals comprising a metal material selected from the group consisting of ferrocene, porphyrin, phthalocyanine and Schiff base R^{X1}R^{X2}—C═N—R^{X3}, wherein R^{X1} and R^{X2} are independently selected from the group consisting of hydrogen, C₁₋₁₂alkyl, C₂₋₁₂alkene, C₂₋₁₂alkyne and mono- and poly-cyclic C₆₋₅₀aryl and wherein R^{X3} is selected from the group consisting of C₁₋₁₂alkyl, C₂₋₁₂alkene, C₂₋₁₂alkyne and mono- and poly-cyclic C₆₋₅₀aryl.

14. Use of a metal-organic framework (MOF) as adsorbent for separating a sulphur compound from a gas mixture, said MOF comprising a tridimensional succession of motifs having the formula:
MₘOₖXₗLₚ
wherein
M is selected from the group of metal ions consisting of Ti⁴⁺, Zr⁴⁺, Mn⁴⁺, Si⁴⁺, Al³⁺, Cr³⁺, V³⁺, Ga³⁺, In³⁺, Mn³⁺, Mn²⁺, Mg²⁺ and combinations thereof;
m is 1, 2, 3 or 4, preferably 1 or 3;
k is 0, 1, 2, 3 or 4, preferably 0 or 1;
l is 0, 1, 2, 3 or 4, preferably 0 or 1;
p is 1, 2, 3 or 4, preferably 1 or 3;
X is selected from the group consisting of OH⁻, Cl⁻, F⁻, Br⁻, SO₄²⁻, NO₃⁻, ClO₄⁻, PF₆⁻, BF₃⁻, —(COO)ₙ⁻, R¹—(S0₃)ₙ⁻, R¹—(PO₃)ₙ⁻, wherein R¹ is selected from the group consisting of hydrogen and C₁₋₁₂alkyl, and wherein n is 1, 2, 3 or 4;
L is a spacer ligand comprising a radical R comprising q carboxylate groups *—COO—#, wherein
q is 1, 2, 3. 4, 5 or 6, preferably 2, 3 or 4;
* shows the carboxylate attachment point to the radical R;
# shows the carboxylate attachment point to the metal ion M;
R is selected from the group consisting of C₁₋₁₂alkyl, C₂₋₁₂alkene, C₂₋₁₂alkyne, mono- and poly-cyclic C₁₋₅₀aryl, mono- and poly-cyclic C₁₋₅₀heteroaryl and organic radicals comprising a metal material selected from the group consisting of ferrocene, porphyrin, phthalocyanine and Schiff base R^{X1}R^{X2}—C═N—R^{X3}, wherein R^{X1} and R^{X2} are independently selected from the group consisting of hydrogen, C₁₋₁₂alkyl, C₂₋₁₂alkene, C₂₋₁₂alkyne and mono- and poly-cyclic C₆₋₅₀aryl and wherein R^{X3} is selected from the group consisting of C₁₋₁₂alkyl, C₂₋₁₂alkene, C₂₋₁₂alkyne and mono- and poly-cyclic C₆₋₅₀aryl.

15. Use of a metal-organic framework (MOF) as adsorbent for separating hydrogen sulphide from a gas mixture, said MOF comprising a tridimensional succession of motifs having the formula:
MₘOₖXₗLₚ
wherein
M is a metal ion V⁴⁺;
m is 1, 2, 3 or 4, preferably 1 or 3;
k is 0, 1, 2, 3 or 4, preferably 0 or 1;
l is 0, 1, 2, 3 or 4, preferably 0 or 1;
p is 1, 2, 3 or 4, preferably 1 or 3;
X is selected from the group consisting of OH⁻, Cl⁻, F⁻, I⁻, Br⁻, SO₄²⁻, NO₃⁻, ClO₄⁻, PF₆⁻, BF₃⁻, —(COO)ₙ⁻, R¹—(S0₃)ₙ⁻, R¹—(PO₃)ₙ⁻, wherein R¹ is selected from the group consisting of hydrogen and C₁₋₁₂alkyl, and wherein n is 1, 2, 3 or 4;
L is a spacer ligand comprising a radical R comprising q carboxylate groups *—COO-#, wherein
q is 1, 2, 3, 4, 5 or 6, preferably 2, 3 or 4;
* shows the carboxylate attachment point to the radical R;
# shows the carboxylate attachment point to the metal ion M;
R is selected from the group consisting of C₁₋₁₂alkyl, C₂₋₁₂alkene, C₂₋₁₂alkyne, mono- and poly-cyclic C₁₋₅₀aryl, mono- and poly-cyclic C₁₋₅₀heteroaryl and organic radicals comprising a metal material selected from the group consisting of ferrocene, porphyrin, phthalocyanine and Schiff base R^{X1}R^{X2}—C═N—R^{X3}, wherein R^{X1} and R^{X2} are independently selected from the group consisting of hydrogen, C₁₋₁₂alkyl, C₂₋₁₂alkene, C₂₋₁₂alkyne and mono- and poly-cyclic C₆₋₅₀aryl and wherein R^{X3} is selected from the group consisting of C₁₋₁₂alkyl, C₂₋₁₂alkene, C₂₋₁₂alkyne and mono- and polycyclic C₆₋₅₀aryl.

16. Method as claimed in claim 2, wherein R is substituted by one or more groups R², independently selected from the group consisting of C₁₋₁₀alkyl, C₂₋₁₀alkene, C₂₋₁₀alkyne, C₃₋₁₀cycloalkyk C₁₋₁₀heteroalkyl, C₁₋₁₀haloalkyl, C₆₋₁₀aryl, C₃₋₁₀heteroaryl , C₅₋₂₀heterocyclic, C₁₋₁₀alkylC₆₋₁₀aryl , C₁₋₁₀alkylC₃₋₁₀heteroaryl , C₁₋₁₀alkoxy , C₆₋₁₀aryloxy , C₃₋₁₀heteroalkoxy , C₃₋₁₀heteroaryloxy, C₁₋₁₀alkylthio , C₆₋₁₀arylthio , C₁₋₁₀heteroalkylthio , C₃₋₁₀heteroarylthio, F, Cl, Br, I, —NO₂, —CN, —CF₃, —CH₂CF₃, —CHCl₂, —OH, —CH₂OH, —CH₂CH₂OH, —NH₂, —CH₂NH₂, —NHCOH, —COOH, —CONH₂, —SO₃H, —CH₂SO₂CH₃, —PO₃H₂, —B(OR^{G1})₂, and a function GR^{G1}, wherein G is selected from the group consisting of —O—, —S—, —NR^{G2}—, —C(═O)—, —S(═O)—, —SO₂—, —C(═O)O—, —C(═O)NR^{G2}—, —OC(═O)—, —NR^{G2}C(═O)—, —OC(═O)O—, —OC(═O)NR^{G2}—, —NR^{G2}C(═O)O—, —NR^{G2}C(═O)NR^{G2}—, —C(═S)—, —C(═S)S—, —SC(═S)—, —SC(═S)S—, —C(═NR^{G2})—, —C(═NR^{G2})O—, —C(═NR^{G2})NR^{G3}—, —OC(═NR^{G2})—, —NR^{G2}C(═NR^{G3})—, —NR^{G2}SO₂—, —NR^{G2}SO₂NR^{G3}—, —NR^{G2}C(═S)—, —SC(═S)NR^{G2}—, —NR^{G2}C(═S)S—, —NR^{G2}C(═S)NR^{G2}—, —SC(═NR^{G2})—, —C(═S)NR^{G2}—, —OC(═S)NR^{G2}—, —NR^{G2}C(═S)O—, —SC(═O)NR^{G2}—, —NR^{G2}C(═O)S—, —C(═O)S—,—SC(═O)—, —SC(═O)S—, —C(═S)O—, —OC(═S)O—, —OC(═S)O— and —SO₂NR^{G2}—, wherein each occurrence of R^{G1}, R^{G2} and R^{G3} is selected, independently from the other occurrences of R^{G1}, from the group consisting of an hydrogen atom, an halogen atom, a C₁₋₁₂alkyl function, a C₁₋₁₂heteroalkyl function, a C₂₋₁₀alkene function, a C₂₋₁₀alkyne function , a C₆₋₁₀aryl group, a C₃₋₁₀heteroaryl group, a C₅₋₁₀heterocycle group, a C₁₋₁₀alkylC₆₋₁₀aryl group and a C₁₋₁₀alkylC₃₋₁₀heteroaryl group, or wherein, when G is —NR^{G2}—, R^{G1} and R^{G2} jointly form in common with the nitrogen atom to which they are linked a heterocycle or a heteroaryl.

17. Method as claimed in claim 10, wherein the gas mixture comprises methane.
